(19) United States
(12) Patent Application Publication
(10) Pub. No.: US 2009/0282062 A1
(43) Pub. Date: Nov. 12, 2009

(54) DATA PROTECTION AND MANAGEMENT

(75) Inventor: Aleksandar Husic, Bradden (GB)

Correspondence Address: MOORE & VAN ALLEN PLLC, P.O. BOX 13706, Research Triangle Park, NC, 27709, US

(73) Assignee: Dovetail Software Corporation Limited, Bradden (GB)

(21) Appl. No.: 12/426,079

(22) Filed: Apr. 17, 2009

Related U.S. Application Data
(63) Continuation-in-part of application No. PCT/GB2007/003992, filed on Oct. 19, 2007.

(30) Foreign Application Priority Data
Oct. 19, 2006 (GB) 0620855.7

(51) Int. Cl. G06F 3/01; G06F 17/30

(52) U.S. Cl. 707/100; 715/760; 707/E17.044

(57) ABSTRACT

A network apparatus comprises a processor connectable to at least one client device via a network, wherein data sent from the processor to the client device may be subject to a pattern recognition process and the system further comprises a data modification module configured to receive data intended for the client device and to insert extraneous characters into the data so as to affect the pattern recognition process.

### CROSS-REFERENCE TO RELATED APPLICATIONS

This is a continuation-in-part of International Application PCT/GB2007/003992, with an international filing date of Oct. 19, 2007, which, in turn, claims priority to application number GB 0620855.7, with a filing date of Oct. 19, 2006; both of which are hereby incorporated herein by reference.

### FIELD OF THE INVENTION

The present invention relates to data protection and management. In certain aspects the present invention relates to a data processing apparatus and method for processing website data, for instance for the creation and editing of websites or for providing protection against web scraping processes.

### BACKGROUND OF THE INVENTION

The indexable web at present comprises over one trillion unique URLs, in excess of 63 billion pages, and in excess of 100 million web sites. Hosting for these URLs, pages and sites is provided by around 100,000 companies, many of whom are resellers acting for around 100 major hosting companies). Most existing pages and web sites are ‘static’, with limited capability, and are run by small enterprises, organisations or individuals for a wide variety of purposes. The management and editing of existing web pages and sites generally requires the input of a web developer expert in HTML coding.

It would be desirable to provide a system that is able to provide for the editing or management of existing or new web pages in an integrated and user-friendly fashion.

Existing large enterprise content management systems, for example SAP, are available, which can provide dynamic functionality for the management of web pages, as part of wider content management systems. However, such systems are usually high cost, comprise complicated server-side functionality, and are intended for small numbers of clients. The degree of complication often precludes integration with other applications, and necessitates large numbers of developers.

At the other end of the product spectrum there are various content management systems (CMS) available for managing the millions of small, static websites out there on the web. Users are enabled to edit the appearance of their static websites (the HTML code and pictures). However, such systems are not able to provide amendment or integration of additional features, in particular dynamic features, into existing websites without writing code.

Turning to web scraping, it is known to use web scraping processes to obtain data from websites. Typically, in a web scraping process the HTML or other code used to generate a web page is requested and received by a web scraper and then data is extracted from the HTML or other code.

HTML code used to generate a web page usually comprises a series of tags within which is code which defines display and other parameters relating to the appearance of the web page. Also within the tags is data which is to be displayed on the web page.

A web scraper typically identifies which data within the tags is data to be displayed on the web page and extracts that data. The extracted data may then be used for any of a wide range of different purposes, but often is displayed on a different website to that from which it was extracted.

In one example, a web scraping process may be applied to, say, a property web page containing output data concerning the prices, addresses and other details of houses or flats for sale. The web scraper requests and receives the HTML code used to generate the web page and extracts the output data concerning the prices, addresses and other details, whilst discarding code concerning display features of the web page, such as colours, sizes and arrangements of tables, and size and font of text. The output data concerning prices, addresses and other details is then displayed together with similar data obtained from other property websites, on a website associated with the web scraper.

In some circumstances, it may be advantageous for a website owner to allow data on a website to be web scraped and used on another site. However, in many circumstances, a website owner wishes to prevent the web scraping of data included on a website.

It is known to use firewall-based techniques in an attempt to stop web scraping. For instance, if the internet address from which a request for data by a web scraper is known, a firewall can be used to block the sending of data in response to requests originating from that address.

Alternatively, a firewall can be set up to block requests for data if those requests seem to match a pattern which indicates that the requests originate from a web scraper. So, for instance, a firewall may be set up to block requests for data if those requests together represent, say, a request for all data available on a particular website over a short period of time, which might be indicative of the requests originating from a web scraper.

The use of firewall-based techniques can present certain disadvantages. For instance, if the address from which a request for data by a web scraper is not known, or if the pattern of requests from a web scraper does not match a known pattern of requests, the firewall may inadvertently allow data to be sent to a web scraper. Alternatively, the firewall may block requests for data as they seem to come from a web scraper when in fact they do not.

### BRIEF SUMMARY OF THE INVENTION

In a first aspect of the invention there is provided a network apparatus comprising a processor connectable to at least one client device via a network, wherein data sent from the processor to the client device may be subject to a pattern recognition process and the apparatus further comprises a data modification module configured to receive data intended for the client device and to insert extraneous characters into the data so as to affect the pattern recognition process.

In a further, independent aspect of the invention there is provided a method of protecting network data, comprising receiving data intended to be sent to a client device via a network and which may be subject to a pattern recognition process, inserting extraneous characters into the data so as to affect the pattern recognition process, and sending the data to the client device.

Preferably, the data comprises executable computer code and the data modification module is configured to insert the extraneous characters so that the presence of the extraneous characters does not interfere with the execution of the computer code.

The data may comprise HTML code and the pattern recognition process may comprise a web-scraping process.

In a further, independent aspect of the present invention there is provided a method of processing computer code, comprising inserting extraneous characters into the computer code.

Thus, an effective method for altering the computer code without affecting operation of desired or authorised processes using the computer code is provided.

Preferably the computer code is executable by a processor and the extraneous characters are inserted such that the computer code, with the extraneous characters inserted, is executable by the processor.

Preferably the presence of the extraneous characters within the computer code does not alter the result of execution of the executable computer code. Typically, the extraneous characters are such that they do not interfere with the execution of the computer code by the processor.

The computer code may comprise data, preferably output data, preferably data to be displayed.

The data may comprise, for instance, parameter values for use in a further process, algorithm or calculation. The output data may be data which is to be displayed, for instance on a computer screen. The output data may comprise, for instance, one or more of prices, quantities, measured values, an indication of a physical characteristic, or an indication of quality relating to, for instance: —property; financial products such as stocks, shares, bonds, currencies, derivatives, or mortgages; experimental data; weather conditions or forecasts; travel information such as timetable information, ticket prices, holiday prices and other information; or entertainment information such as TV schedules, theatre or cinema listings, and ticket availability or prices.

Preferably the extraneous characters are such that the display of the data to be displayed is not affected by the presence of the extraneous characters.

The computer code, in the absence of the extraneous characters, may be such that output data may be extracted from the computer code by subjecting the computer code to a pattern recognition process.

The extraneous characters may be such as to affect operation of the pattern recognition process.

The use of extraneous characters provides a particularly efficient and effective way of affecting operation of a pattern recognition process.

In particular, the extraneous characters may be such as to alter the output data which may be extracted by the pattern recognition process from the computer code inclusive of the extraneous characters, compared to the output data which may be extracted by the pattern recognition process from the computer code exclusive of the extraneous characters.

Preferably the output data is affected such as to make it unuseable for its intended purpose, or to interfere with its use for that intended purpose. For instance if the computer code includes display data then the presence of extraneous characters may ensure that operation of a pattern recognition process intended to extract the display data instead extracts only a part of the display data, or none of the display data, either alone or in combination with some or all of the extraneous characters or other characters, or instead extracts all of the display data but only in combination with some or all of the extraneous characters or other characters. In that case, display of the extracted data may be misleading or incorrect, or may not be possible.

The extraneous characters may be such as to prevent extraction of the output data from the computer code by the pattern recognition process.

The pattern recognition process may comprise a web scraping process.

The insertion of extraneous characters is particularly effective in interfering with operation of a web scraping process.

The step of inserting the extraneous characters may comprise inserting the extraneous characters at pre-determined locations within the computer code. Preferably the pre-determined locations are inserted in accordance with a pattern.

The pre-determined locations and/or the pattern may be determined by operation of an algorithm. The algorithm may be varied. The algorithm may be updated in response to changes or expected changes in a pattern recognition process which might be applied to the computer code. The pattern may be random or pseudo-random.

The method may further comprise varying the pattern, preferably after a pre-determined time interval and/or in response to receipt of a request for the computer code or a portion of the computer code.

The method may further comprise updating the computer code by varying the extraneous characters and/or reinserting the extraneous characters in different positions.

The method may further comprise updating the computer code after a pre-determined time interval and/or in response to receipt of a request for the computer code or a portion of the computer code

The step of inserting the extraneous characters may comprise reading the computer code, identifying at least one target point within the computer code and inserting each of the extraneous characters relative to the target point or one of the target points.

The target point or at least one of the target points may be associated with a feature of the computer code, such as a command or attribute, or a start or end point. The target point or at least one of the target points may be associated with a tag. The target point or at least one of the target points may comprise at least one of a start tag or an end tag or a pre-determined command.

The computer code may comprise computer code accessible via a network. The network may comprise a publically accessible network, preferably the internet. The computer code may comprise high-level computer code. In particular, the computer code may comprise application layer computer code. The computer code may comprise C, C++, Fortran, Basic, Visual Basic, or Java. The computer code comprises code in a mark-up language or a tag based language, and the mark-up language may comprise Hypertext Mark-up Language (HTML). The computer code may comprise SGML, XML, HTML, XHTML, ColdFusion, or RSS.

The step of inserting the extraneous characters may comprise inserting extraneous characters within at least one tag.

The extraneous characters may comprise a sequence of characters which resembles an instruction. The sequence of characters may resemble an instruction which a processor able to process the computer code would recognise. Preferably the sequence of characters resembles a genuine instruction sufficiently that a web scraping or pattern recognition process based upon recognition of instructions would be affected, but is not a genuine instruction so that it does not cause a processor suitable for carrying out genuine instructions to carry out an action, or to crash. Preferably the extraneous characters do not affect operation of a processor suitable for carrying out genuine instructions. Thus there is provided a particularly effective way of interfering with pattern recognition processes which recognises instructions.

The sequence of characters may resemble an attribute and preferably an associated sequence of characters resembles a value of the attribute. The sequence of characters may resemble an attribute which a processor able to process the computer code would recognise. Preferably the sequence of characters resembles a genuine attribute sufficiently that a web scraping or pattern recognition process based upon recognition of attributes would be affected, but is not a genuine attribute so that it does not cause a processor suitable for processing genuine attributes to carry out an action, or to crash. Preferably the extraneous characters do not affect operation of a processor suitable for processing genuine attributes. Thus there is provided a particularly effective way of interfering with pattern recognition processes which recognises attributes. An attribute may be, for instance, a piece of computer code for producing a particular display feature. The display feature may be, for instance, a table, text box, row, column, frame or picture, or may comprise a characteristic, for instance the colour, size or shape, of such a feature.

The extraneous characters comprise a random or quasi-random sequence of characters.

The extraneous characters may comprise text characters. In particular the extraneous characters may comprise characters from the ASCII character set.

Preferably the method further comprises performing an authorisation process and inserting the extraneous characters in dependence upon the outcome of the authorisation process. Thus, if desired a pattern recognition process may be allowed to be carried out by an authorised user, and may not be allowed to be carried out by an unauthorised user.

The authorisation process may comprise a password input process, and preferably the method comprises inserting the extraneous characters if a correct password is not input. Alternatively or additionally, the authorisation process may comprise receiving an identifier and comparing the identifier to a list of authorised identifiers. The identifier may comprise an identifier associated with the source of a request for the computer code or a portion of the computer code, and preferably the identifier comprises an address.

Preferably the method is a method of protecting a website from web scraping, comprising reading HTML code included in the website, and performing the step of inserting extraneous characters into computer code by inserting the extraneous characters into the HTML code.

In another independent aspect of the invention there is provided a method of protecting network data, comprising receiving data intended to be sent to a client device via a network and which may be subject to a pattern recognition process, inserting extraneous characters into the data so as to affect the pattern recognition process in accordance with a method as claimed in any of Claims 7 to 39, and sending the data to the client device.

In a further independent aspect of the invention there is provided apparatus for processing computer code, comprising means (for instance a processor and/or a data modification module) for inserting extraneous characters into the computer code.

Preferably the apparatus comprises means for receiving the computer code.

Preferably the computer code is executable and the extraneous characters are inserted such that the computer code, with the extraneous characters inserted, is executable.

Preferably the computer code comprises output data, preferably data to be displayed. The computer code, in the absence of the extraneous characters, may be such that output data may be extracted from the computer code by subjecting the computer code to a pattern recognition process. The extraneous characters may be such as to affect operation of the pattern recognition process.

The extraneous characters may be such as to alter the output data which may be extracted by the pattern recognition process from the computer code inclusive of the extraneous characters, compared to the output data which may be extracted by the pattern recognition process from the computer code exclusive of the extraneous characters. The extraneous characters may be such as to prevent extraction of the data from the computer code by the pattern recognition process.

The pattern recognition process may comprise a web scraping process.

The means for inserting extraneous characters may be configured to insert the extraneous characters at pre-determined locations within the computer code. Preferably, the pre-determined locations are inserted in accordance with a pattern. The apparatus may comprise means for varying the pattern, preferably after a pre-determined time interval and/or in response to receipt of a request for the computer code or a portion of the computer code.

The means for inserting extraneous characters may be configured to update the computer code by varying the extraneous characters and/or reinserting the extraneous characters in different positions. Preferably, the means for inserting extraneous characters is configured to update the computer code after a pre-determined time interval and/or in response to receipt of a request for the computer code or a portion of the computer code.

The means for inserting extraneous characters may be configured to read the computer code, identify at least one target point within the computer code and insert each of the extraneous characters relative to the target point or one of the target points. Preferably the target point or at least one of the target points is associated with a tag. The target point or at least one of the target points may comprise at least one of a start tag or an end tag or a pre-determined command.

The computer code may comprise computer code accessible via a network. The network may comprise a publically accessible network, preferably the internet. The computer code may comprise high-level computer code. The computer code may comprise application layer computer code. The computer code may comprise code in a mark-up language or a tag based language. The mark-up language may comprise Hypertext Mark-up Language (HTML).

The means for inserting extraneous characters may be configured to insert extraneous characters within at least one tag.

The extraneous characters may comprise a sequence of characters which resemble an instruction. The sequence of characters resembles an attribute and preferably an associated sequence of characters resembles a value of the attribute. The extraneous characters may comprise a random or quasi-random sequence of characters. The extraneous characters may comprise text characters. The extraneous characters may comprise characters from the ASCII character set.

Preferably, the apparatus further comprises means for performing an authorisation process and the means for inserting extraneous characters is configured to insert the extraneous characters in dependence upon the outcome of the authorisation process.

Preferably, the authorisation process comprises a password input process, and preferably the means for inserting extraneous characters is configured to insert the extraneous characters if a correct password is not input.

Preferably the means for performing an authorisation process comprises means for receiving an identifier and comparing the identifier to a list of authorised identifiers. The identifier may comprise an identifier associated with the source of a request for the computer code or a portion of the computer code, and preferably the identifier comprises an address.

The apparatus may be configured to protect a website from web scraping and may comprise means for reading HTML code included in the website, wherein the means for inserting extraneous characters may be configured to insert the extraneous characters into the HTML code.

In a further, independent aspect of the invention there is provided a network system comprising a processor connectable to at least one client device via a network, wherein data sent from the processor may be subject to a pattern recognition process and the system further comprises apparatus according to any of Claims 41 to 73 configured to receive data sent from the processor and intended for the client device and to insert extraneous characters into the data so as to affect the pattern recognition process.

In another, independent aspect of the invention, there is provided an object-oriented processing method, comprising providing a graphical user interface and creating a new object or a new instance of an object or altering an existing object or an existing instance of an object in dependence upon input from a user via the graphical user interface.

Thus, a user is able to create and manage objects without needing to program directly, or to write any computer code. Objects may be created and managed automatically by the processing means in dependence upon the input via the graphical user interface.

As used herein the term object refers to an object in an object-oriented data processing or management system. Each object and instance may be coded using known object oriented processing techniques.

In the preferred embodiment, the system is developed is implemented as a J2EE software platform. The actual programming language used is Java 1.5, in conjunction with JSP. It runs on top of any JSP software and JVM (Java Virtual Machine) 1.5. It can be installed and implemented on any server, desktop or laptop computer running any of the major Operating Systems (Windows, UNIX, Linux, Solaris, Mac Os X). It can be implemented in conjunction with any major database software package (Oracle, SqlServer, MySql, Sybase, etc).

Typically the graphical user interface may be used to display data concerning many objects and instances a user is able to manage the objects and instances and the relationship between them via the graphical user interface. Thus a simple, object-oriented system can be provided which can be used to manage and process data of many different types and which does not require any coding on the part of the user.

Objects may represent, for instance, concrete or abstract entities. Objects may represent executable processes.

Typically each object has a plurality of properties. Data or processes can be represented using an object by assigning a respective value or definition to each property of the object. An instance of an object comprises the set of values or definitions of the properties of the object.

In the case of an object representing an executable process, the object may define the process steps, and an instance of the object may comprise parameters of the process. A process represented by the object may be executed by reading the instance in order to obtain parameters of the process, reading the object and populating the steps of the process defined by the object with the parameters obtained from the instance and carrying out the resulting steps of the process. That may be referred to as execution of an instance of an executable object, or as execution of an instance.

In the case of an object representing a concrete entity, properties of the object may correspond to properties of the entity. For instance, in a business environment an object may represent, for example, a product or a part of a product, a customer, an employee, a transaction, a piece of correspondence, or an enquiry. In such examples, properties may include for instance colour, size, price, product reference, name address, date.

In a production environment, an object may represent, for example, a piece of equipment, a production process, or a product. In such examples properties may include for instance location, age, servicing requirements, conditions of operation such as temperature, time, or input materials.

Preferably the method comprises assigning properties to the new object or changing properties of the existing object in dependence upon input from a user via the graphical user interface.

Changing properties of an existing object may comprise adding or removing a property of the object, or changing an existing property.

The method may comprise creating relationships between the new object and other objects or changing relationships between the new object and other objects in dependence upon input from a user via the graphical user interface.

A relationship may comprise rules for how one object can interact with another object, or rules determining how properties of one object may affect properties of another object, and in particular how properties of one object are inherited by another object. A relationship may be a parent-child relationship. Relationships may be defined or represented by a property or properties of the or each object in question.

Preferably the method comprises creating an instance of an object by assigning values or definitions to the properties of an object, or changing the values or definitions of an existing instance of an object, in dependence upon input from a user via the graphical user interface.

The instance may be created or changed by entry of parameters by a user via the graphical user interface, each parameter setting a value of a respective property of the object. Alternatively or additionally, the user may select existing data and the existing data may be used to set values of properties of the object.

The graphical user interface may comprise selection means, and the input from the user comprises selection by the user using the selection means.

The input from the user may comprise at least one of: —selection from a list displayed by the graphical user interface, entry of text into a text box, or selection of a selectable button.

The graphical user interface may be configured such that a user can select a piece of data using the selection means of the graphical user interface.

Preferably, data may be selected from any location to which the processing means may connect, and the data may be of a variety of different types.

The graphical user interface may be configured to determine whether the selected piece of data is associated with an object. Preferably the graphical user interface is configured so that the user can select an object and associate the selected piece of data with the object using the graphical user interface.

The method may comprise determining whether the selected piece of data is represented by an instance of an object, and preferably comprises generating a signal to indicate to the user whether the selected piece of data is represented by an instance of an object.

Preferably the method comprises generating an instance of the object associated with the selected piece of data, the generated instance being representative of the selected piece of data.

The method may further comprise providing a plurality of objects, each object either being created in dependence upon input by a user via a graphical user interface or being provided as part of a processing means. The processing means may comprise or be associated with a plurality of related objects and at least some of the objects may be executable, wherein execution of each executable object causes a respective process to be carried out.

Preferably the plurality of related objects comprises a parent object, and preferably each other of the plurality of related objects is a child of the parent object.

Preferably, the objects are interlinked such as to provide a data processing system, preferably a self-contained data processing system.

In a further, independent aspect there is provided an object-oriented processing method comprising providing a plurality of interlinked objects and instances of the objects, wherein at least some of the objects or instances of the objects are executable such as to provide a data processing system including a graphical user interface, and preferably the data processing system is a self-contained data processing system.

The processing means may comprise or be associated with a data store. The data store may store objects and/or instances of objects and preferably stores the plurality of related objects. The data store may be updated to reflect changes to objects or instances.

Preferably the data store comprises a plurality of tables. The plurality of tables may comprise fewer than 50 tables, preferably fewer than 30 tables, and more preferably 20 tables or fewer than 20 tables.

The method may further comprise providing an executable program, execution of the executable program causing start-up of the or a processing means and display of the graphical user interface.

The processing means may be stored in a first memory and execution of the executable program may cause export of the processing means and/or the data store from the first memory to a second memory, and preferably the second memory is local memory and/or RAM.

Operation of the processing means may cause changes to the data stored in the data store of the processing means in the second memory.

The method may further comprise updating the data store stored in the first memory so that data stored in the data store in the first memory matches the data stored in the data stored in the second memory.

Preferably the graphical user interface is configured so that a user is able to select at least one location where pieces of data which can be selected by the user may be located. The at least one location may comprise a storage area on a hard disc drive. Alternatively or additionally the at least one location may comprise a network location.

The at least one location may comprise a webpage or a database location. The piece of data may be for creation of a display region. The piece of data may comprise display data or may represent display data. The piece of data may be a piece of data that can be used to generate a webpage.

The method may further comprise providing an object, an instance of the object being representative of the piece of data.

In a further, independent aspect there is provided a method of processing a webpage, comprising providing an object associated with a piece of data used to generate a webpage, an instance of the object being representative of a piece of data used to generate a webpage.

The method may further comprise receiving an instruction from a user via a or the graphical user interface and creating the object in accordance with the instruction. The method may further comprise creating the piece of data from the object.

The method may further comprise processing the object representative of a piece of data used in generation of a webpage.

The processing of the object may comprise creating an instance of the object or changing an instance of the object.

Preferably the processing of the object is such as to alter at least one feature of the webpage. The at least one feature of the webpage may comprise, for instance, a table, a cell, text, a text input box, a button, an image, a display region for an image, a background, or a border.

The processing of the object may be in response to an instruction from a user. Preferably the method further comprises receiving the instruction from the user via the or a graphical user interface.

The graphical user interface may be configured to display a list of possible features of the webpage and the instruction from the user comprises a selection from the list. The graphical user interface may be configured to display a list of possible characteristics of a feature of the webpage and the instruction from the user comprises a selection from the list. The characteristics may include, for instance, position, colour, size, shape, language, shading, font type, or font size.

The piece of data may comprise a portion of computer code. The computer code may comprise computer code in a mark-up language, preferably hypertext mark-up language (HTML).

Preferably the method comprises, for each of a plurality of pieces of HTML code together representative of the web page, creating a respective object representative of the piece of HTML code.

Preferably the method comprises, for each of a plurality of pieces of HTML code together representative of the web page, providing a respective instance of an object, the instance being representative of the piece of HTML code.

The method may further comprise altering one or more of the objects or altering a respective instance of each of one or more of the objects. The method may comprise receiving the HTML code and identifying the plurality of pieces of HTML code.

Preferably the method is a method of editing the web page or a method of creating the web page.

The method may be a method of creating the web page, the method comprising creating the plurality of pieces of HTML code from the objects.

The piece of data may comprise database data.

The method may comprise receiving a request for database data, determining whether the requested database data is represented by an instance of an object, and if the database data is not represented by an instance of an object create an instance of an object representing the database data.

The method may further comprise providing the instance of an object representing the database data rather than the database data in response to the request.

In a further, independent aspect there is provided a method of managing a database, comprising receiving a request for database data, determining whether the requested database data is represented by an instance of an object, if the database data is not represented by an instance of an object creating an instance of an object representing the database data, and providing the instance of an object representing the database data rather than the database data in response to the request.

The request for data may be generated in response to a user input to the or a graphical user interface.

The method may further comprise receiving a request to process database data and processing the object associated with the database data in response to the request.

Preferably the processing of the object associated with the database data comprises creating an instance of the object or changing an instance of the object, the instance of the object being representative of the database data. The change in the instance of an object may be representative of a change to database data.

The method may further comprise updating a database containing database data so as to include the change in database data represented by the change in the instance.

The method may further comprise providing a plurality of objects each associated with respective database data and creating relationships between the objects.

Preferably the database data is a database entry or a database row or a database column or a response to a database query.

The method may further comprise relating the object representing the database data to at least one other object representing other database data. Preferably the method further comprises relating the object to the at least one other object by specifying attributes of the object and the at least one other object.

The object may represent database data from a first database and at least one of the at least one other objects may represent database data from a second database.

The method may be a method of processing database data from a plurality of databases, wherein the location of each piece of database data is represented by a respective property of a respective object.

The database data may comprise relational database data.

The method may further comprise creating an associated database table entry upon creation of an object.

The method may further comprise, upon creating or changing an instance of the object, modifying the content of the associated database table to reflect the creation of or change in the instance of the object.

The database table may be a relational database table.

The method may comprise determining the format of the piece of data.

The method may further comprise providing an object associated with the piece of data.

The method may further comprise processing the object to generate the piece of data in a different format.

The step of processing the object may comprise creating or changing an instance of the object, the instance of the object being representative of the piece of data.

In a further, independent aspect there is provided a method of converting a piece of data from a format to a different format, comprising providing an object associated with the piece of data, an instance of the object being representative of the piece of data, and generating from the object the piece of data in a different format.

The method may comprise providing the object and/or generating the piece of data in a different format, in dependence upon the outcome of an authorisation process.

The authorisation process may comprise a password input process, and preferably the method comprises creating the object and/or generating the piece of data in a different format if a correct password is input.

Preferably the authorisation process comprises determining whether a user has subscribed to a subscription service.

The method may further comprise, for the or each user, providing an associated object.

The object associated with the user may include a plurality of properties each representing a respective characteristic or activity of the user.

The method may comprise providing in respect of each user a respective instance of the object.

Preferably the method further comprises updating the instance of each user in dependence upon activities of the user.

The method may comprise limiting the activities of each user in dependence upon the respective instance of the associated object.

Preferably the method comprises determining the data to be displayed to the user using the or a graphical user interface in dependence upon the respective instance of the associated object.

In a further, independent aspect of the invention there is provided object-oriented processing apparatus, comprising a graphical user interface and an associated processing means (for example, a processor or processing module and/or a set of interlinked objects and instances), the processing means being configured to create a new object or a new instance of an object or to alter an existing object or an existing instance of an object in dependence upon input from a user via the graphical user interface.

Preferably, the processing means is configured (for example, by provision of a sub-module or executable instance and associated object or a set of interlinked executable instances and associated objects) to assign properties to the new object or changing properties of the existing object in dependence upon input from a user via the graphical user interface.

The processing means may be configured (for example, by provision of a sub-module or executable instance and associated object or a set of interlinked executable instances and associated objects) to create relationships between the new object and other objects or to change relationships between the new object and other objects in dependence upon input from a user via the graphical user interface.

The processing means may be configured (for example, by provision of a sub-module or an executable instance and associated object or a set of interlinked executable instances and associated objects) to create an instance of an object by assigning values or definitions to the properties of an object, or to change the values or definitions of an existing instance of an object, in dependence upon input from a user via the graphical user interface.

Preferably, the graphical user interface comprises selection means (for example, one or more of a window, pointer, button, list, and menu), and the input from the user comprises selection by the user using the selection means.

The graphical user interface may be configured such that a user can select a piece of data using the selection means of the graphical user interface.

The processing means may be configured (for example, by provision of a sub-module or an executable instance and associated object or a set of interlinked executable instances and associated objects) to determine whether the selected piece of data is associated with an object.

The graphical user interface may be configured so that the user can select an object and associate the selected piece of data with the object using the graphical user interface.

The processing means may be configured (for example, by provision of a sub-module or an executable instance and associated object or a set of interlinked executable instances and associated objects) to determine whether the selected piece of data is represented by an instance of an object, and preferably comprises means for generating a signal to indicate to the user whether the selected piece of data is represented by an instance of an object.

The processing means may be configured (for example, by provision of an executable instance and associated object or a set of interlinked executable instances and associated objects) to generate an instance of the object associated with the selected piece of data, the generated instance being representative of the selected piece of data.

The apparatus may comprise a plurality of objects, each object either being created in dependence upon input by a user via a graphical user interface or being provided as part of the processing means.

The processing means may comprise a plurality of related objects with at least some of the objects being executable, wherein execution of each executable object causes a respective process to be carried out.

The plurality of related objects may comprise a parent object, and preferably each other of the plurality of related objects is a child of the parent object.

The objects may be interlinked such as to provide a data processing system, preferably a self-contained data processing system.

In a further, independent aspect of the invention there is provided apparatus for processing data comprising a plurality of interlinked objects and instances of the objects, wherein at least some of the objects or instances of the objects are executable such as to provide a data processing system including a graphical user interface, and preferably the data processing system is a self-contained data processing system.

The processing means may comprise or be associated with a data store. The data store may store objects and/or instances of objects and preferably stores the plurality of related objects.

The apparatus may further comprise means (for example, an executable instance and associated object or a set of interlinked executable instances and associated objects) for updating the data store to reflect changes to objects or instances.

The data store may comprise a plurality of tables. The number of the tables may be fewer than 50, preferably fewer than 30, and more preferably 20 or fewer than 20.

Preferably the apparatus comprises an executable program, execution of the executable program causing start-up of the processing means and display of the graphical user interface.

The processing means may be stored in a first memory and execution of the executable program may cause export of the processing means and/or the data store from the first memory to a second memory, and preferably the second memory is local memory and/or RAM. Operation of the processing means may cause changes to the data stored in the data store of the processing means in the second memory.

The apparatus may further comprise means (for example, an executable instance and associated object or a set of interlinked executable instances and associated objects) for updating the data store stored in the first memory so that data stored in the data store in the first memory matches the data stored in the data stored in the second memory.

The graphical user interface may comprise means (for instance a file manager) for a user to select at least one location where pieces of data which can be selected by the user may be located. The at least one location may comprise a storage area on a hard disc drive and/or a network location and/or a webpage and/or a database location.

The piece of data may be for creation of a display region. The piece of data may comprise display data or may represent display data.

Preferably, the piece of data can be used to generate a webpage. The apparatus may further comprise an object, an instance of which is representative of the piece of data.

In a further, independent aspect of the invention there is provided apparatus for processing a web page, comprising a processing means (for example, a processor or processing module and/or a set of interlinked objects and instances) configured to generate an object associated with a piece of data used to generate a webpage, an instance of the object being representative of a piece of data used to generate a webpage.

The apparatus may further comprise means (for example, an executable instance and associated object or a set of interlinked executable instances and associated objects) for receiving an instruction from a user via a graphical user interface as recited herein and means for creating the object in accordance with the instruction.

The processing means may be configured (for example, by provision of a sub-module or an executable instance and associated object or a set of interlinked executable instances and associated objects) to creating the piece of data from the object.

The processing means may be configured (for example, by provision of an executable instance and associated object or a set of interlinked executable instances and associated objects) to process the object representative of a piece of data used in generation of a webpage. The processing of the object may comprise creating an instance of the object or changing an instance of the object. The processing of the object may be such as to alter at least one feature of the webpage. The processing of the object may be in response to an instruction from a user.

The apparatus may further comprise means (for instance, one or more of a window, pointer, button, list, link, or menu) for receiving the instruction from the user via the or a graphical user interface.

The graphical user interface may comprise means (for instance, one or more of a window, list, text box or menu) for displaying a list of possible features of the webpage and the instruction from the user may comprise a selection from the list.

The graphical user interface may comprise means (for instance, one or more of a window, list, text box or menu) for displaying a list of possible characteristics of a feature of the webpage and the instruction from the user comprises a selection from the list.

The or a piece of data may comprise a portion of computer code.

The computer code may comprise computer code in a mark-up language, preferably hypertext mark-up language (HTML).

The processing means may be configured (for example, by provision of a sub-module or an executable instance and associated object or a set of interlinked executable instances and associated objects) to create a respective object representative of each of a plurality of pieces of HTML code together representative of the web page.

In a further, independent aspect there is provided apparatus for processing a web page comprising processing means (for example, a processor or processing module and/or a set of interlinked objects and instances) configured to provide a respective instance of an object representative of each of a plurality of pieces of HTML code together representative of the web page.

Preferably the processing means is configured (for example, by provision of a sub-module or an executable instance and associated object or a set of interlinked executable instances and associated objects) to alter one or more of the objects or altering a respective instance of each of one or more of the objects.

The processing means may be configured (for example, by provision of a sub-module or an executable instance and associated object or a set of interlinked executable instances and associated objects) to receive the HTML code and identifying the plurality of pieces of HTML code.

Preferably, the apparatus is operable to edit the web page or to create the web page. Preferably the apparatus is operable to create the web page and comprises means (for example, an executable instance and associated object or a set of interlinked executable instances and associated objects) for creating the plurality of pieces of HTML code from the objects.

The piece of data may comprise database data. The processing means may be configured (for example, by provision of a sub-module or an executable instance and associated object or a set of interlinked executable instances and associated objects) to receive a request for database data, to determine whether the requested database data is represented by an instance of an object, and if the database data is not represented by an instance of an object to create an instance of an object representing the database data.

The processing means may be configured (for example, by provision of a sub-module or an executable instance and associated object or a set of interlinked executable instances and associated objects) for providing the instance of an object representing the database data rather than the database data in response to the request.

In a further, independent aspect of the invention there is provided database management apparatus, comprising processing means (for example, a processor or processing module and/or a set of interlinked objects and instances) configured to receiving a request for database data, to determine whether the requested database data is represented by an instance of an object, and if the database data is not represented by an instance of an object to create an instance of an object representing the database data, and to provide the instance of an object representing the database data rather than the database data in response to the request.

The request for data may be generated in response to a user input to the or a graphical user interface.

The processing means may be configured (for example, by provision of a sub-module or an executable instance and associated object or a set of interlinked executable instances and associated objects) to receive a request to process database data to process the object associated with the database data in response to the request.

Preferably the processing of the object associated with the database data comprises creating an instance of the object or changing an instance of the object, and the instance of the object may be representative of the database data. The change in the instance of an object is representative of a change to database data.

The processing means may be configured (for example, by provision of a sub-module or an executable instance and associated object or a set of interlinked executable instances and associated objects) to update a database containing database data so as to include the change in database data represented by the change in the instance.

The apparatus may further comprise a plurality of objects each associated with respective database data and means (for example, an executable instance and associated object or a set of interlinked executable instances and associated objects) for creating relationships between the objects.

The database data may comprise a database entry or a database row or a database column or a response to a database query.

The processing means may be configured (for example, by provision of a sub-module or an executable instance and associated object or a set of interlinked executable instances and associated objects) to relate the object representing the database data to at least one other object representing other database data.

The processing means may be configured (for example, by provision of a sub-module or an executable instance and associated object or a set of interlinked executable instances and associated objects) to relate the object to the at least one other object by specifying attributes of the object and the at least one other object. Preferably the object represents database data from a first database and at least one of the at least one other objects represents database data from a second database.

The apparatus may be apparatus for processing database data from a plurality of databases, and the location of each piece of database data may be represented by a respective property of a respective object. The database data may comprise relational database data.

The processing means may be configured (for example, by provision of a sub-module or an executable instance and associated object or a set of interlinked executable instances and associated objects) to create an associated database table entry upon creation of an object.

The processing means may be configured (for example, by provision of a sub-module or an executable instance and associated object or a set of interlinked executable instances and associated objects) to modify the content of an associated database table to reflect the creation of or change in the instance of an object upon creating or changing an instance of the object. The database table may be a relational database table.

The processing means may be configured (for example, by provision of a sub-module or an executable instance and associated object or a set of interlinked executable instances and associated objects) to determine the format of the piece of data. The apparatus may comprise an object associated with the piece of data.

The processing means may be configured (for example, by provision of a sub-module or an executable instance and associated object or a set of interlinked executable instances and associated objects) to process the object to generate the piece of data in a different format.

The processing means may be configured (for example, by provision of a sub-module or an executable instance and associated object or a set of interlinked executable instances and associated objects) to create or change an instance of the object, the instance of the object being representative of the piece of data.

In a further, independent aspect of the invention there is provided apparatus for converting a piece of data from a format to a different format, comprising an object and processing means (for example, a processor or processing module and/or a set of interlinked objects and instances) for generating an instance of the object, the instance being representative of the piece of data, the processing means being configured to generate from the object the piece of data in a different format.

The apparatus may further comprise means (for example, an executable instance and associated object or a set of interlinked executable instances and associated objects) for carrying out an authorisation process and means (for example, an executable instance and associated object or a set of interlinked executable instances and associated objects) for providing the object and/or generating the piece of data in a different format, in dependence upon the outcome of the authorisation process.

The authorisation process may comprise a password input process, and preferably the apparatus comprises means (for example, an executable instance and associated object or a set of interlinked executable instances and associated objects) for creating the object and/or generating the piece of data in a different format if a correct password is input.

The means for carrying out an authorisation process may comprise means (for example, an executable instance and associated object or a set of interlinked executable instances and associated objects) for determining whether a user has subscribed to a subscription service.

The apparatus may further comprise a respective object associated with the or each user. The object associated with the user may include a plurality of properties each representing a respective characteristic or activity of the user. The apparatus may comprise means (for example, an executable instance and associated object or a set of interlinked executable instances and associated objects) for providing in respect of each user a respective instance of the object.

The apparatus may further comprise means (for example, an executable instance and associated object or a set of interlinked executable instances and associated objects) for updating the respective instance provided in respect of each user in dependence upon activities of the user. Preferably the apparatus further comprises means (for example, an executable instance and associated object or a set of interlinked executable instances and associated objects) for limiting the activities of each user in dependence upon the respective instance of the associated object.

The apparatus may comprise means (for example, an executable instance and associated object or a set of interlinked executable instances and associated objects) for determining data to be displayed to the user using the or a graphical user interface in dependence upon the respective instance of the associated object.

In a further independent aspect there is provided a computer program product storing computer executable instructions operable to cause a general purpose computer to become configured to perform a method as claimed or as described herein.

In another independent aspect there is also provided a computer program product storing computer executable instructions operable to cause a general purpose computer to become configured as apparatus as claimed or as described herein.

The present invention can be implemented in any convenient form, for example using dedicated hardware, or a mixture of dedicated hardware and software. The present invention is particularly suited to implementation as computer software implemented by a server system or workstation or laptop computer. The invention may further be implemented on, or comprise, a network, which can include any local area network or even wide area, conventional terrestrial or wireless communications network. The apparatus may comprise any suitably programmable apparatus such as a general-purpose computer, personal digital assistant, mobile telephone (such as a WAP or 3G-compliant phone) and so on. Aspects of the present invention encompass, or are implemented by, computer software implementable on a programmable device. The computer software can be provided to the programmable device using any conventional carrier medium. The carrier medium can comprise a transient carrier medium such as an electrical, optical, microwave, acoustic or radio frequency signal carrying the computer code. An example of such a transient medium is a TCP/IP signal carrying computer code over an IP network, such as the Internet. The carrier medium can also comprise a storage medium for storing processor readable code such as a floppy disk, hard disk, CD ROM, magnetic tape device or solid-state memory device.

Other aspects of the invention are as set out in the appended claims.

Any feature in one aspect of the invention may be applied to another aspect of the invention, in any appropriate combination. In particular, apparatus features may be applied to method features and vice versa.

### BRIEF DESCRIPTION OF THE DRAWINGS

Preferred features of embodiments of the invention will now be described, purely by way of example, and with reference to the accompanying drawings in which:—

FIG. 1 is a schematic diagram showing in overview the transmission of data and data requests between a server and web browsers via the internet;

FIG. 2 is a schematic diagram showing components of a server arranged to perform a character insertion process;

FIG. 3 is a flowchart illustrating an example of a process of insertion of extraneous characters;

FIG. 4 is a schematic diagram showing the layout of a web page;

FIG. 5 is a schematic diagram showing in overview the structure of the preferred embodiment of an object-oriented processing system;

FIG. 6 is a set of tables included in the preferred embodiment of the object-oriented processing system;

FIG. 7 is an example of a programming tag for the system object Hyperlink;

FIG. 8 is a flowchart illustrating in overview the steps taken in initial execution of the object-oriented processing system;

FIG. 9 is a schematic illustration of the basic layout of the initial GUI window displayed to a user with administrator permissions;

FIG. 10 is an illustration of the Actions drop-down menu;

FIG. 11 is an illustration of the Object Manager window;

FIG. 12 is an illustration of the Properties Manager window;

FIG. 13 is an illustration of the Property Creation and Editing window;

FIG. 14 is an illustration of the Instance Creation and Editing window;

FIG. 15 is an illustration of the Styles Editing window;

FIG. 16 is an illustration of the Styles Selection window;

FIG. 17 is an illustration of the Javascript Events Editing window;

FIG. 18 is an illustration of the Permissions window;

FIG. 19 is a flowchart showing in overview the sequence of in which elements of the system are used in order to display or export data;

FIG. 20 is an illustration of the Publish window;

FIG. 21 is an illustration of the Tracking window;

FIG. 22 is an illustration of the Groups window;

FIG. 23 is a flowchart illustrating in overview the steps taken in displaying the Object Manager window;

FIG. 24 is a flowchart illustrating in overview the steps taken in creating a new object;

FIG. 25 is a flowchart illustrating in overview the steps taken in editing object properties;

FIG. 26 is a flowchart illustrating in overview the steps taken in adding an instance;

FIG. 27 is a flowchart illustrating in overview the steps taken in editing an instance;

FIG. 28 is an illustration of an applications window;

FIG. 29 is an illustration of a window used to address and manage a legacy database;

FIG. 30 is a flowchart illustrating in overview the steps taken in reading and displaying database data;

FIG. 31 is a flowchart illustrating in overview the steps taken in reading and updating database data;

FIG. 32 is an illustration of a GUI window used in creating, editing or interlinking of webpages;

FIG. 33 is a flowchart illustrating in overview the steps taken in a web-page creation process; and

FIG. 34 is a flowchart illustrating in overview the steps taken in a web-page download and editing process.

### DETAILED DESCRIPTION OF THE INVENTION

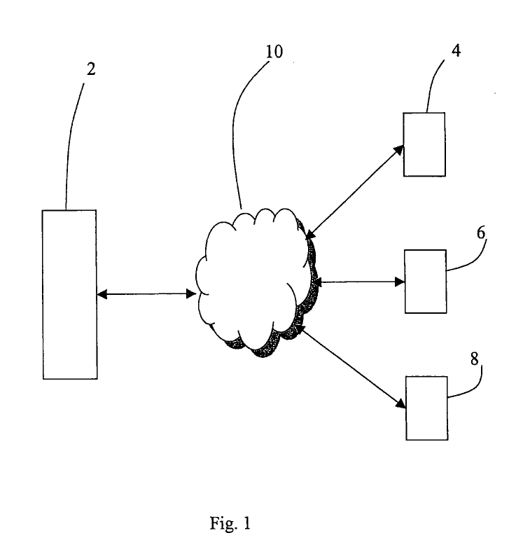

A processor in a preferred embodiment of one aspect of the invention, in the form of a server 2, is shown in FIG. 1.

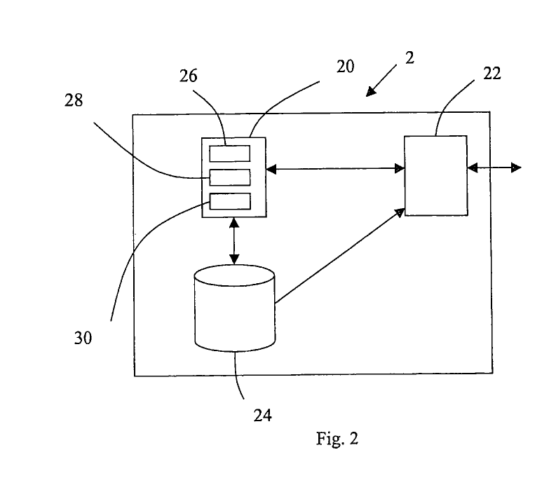

The server 2 is shown schematically in more detail in FIG. 2. The server 2 includes an application layer processor 20, a transport and network layer processor 22 and a data modification module 30. The data modification module 30 is also known as a data scraping protector module, and includes an HTML processor. The server 2 also includes a storage device 24 connected to each of the application layer processor 20 and the transport and network layer processor 22.

In the preferred embodiment, the application layer processor 20 is a general purpose processor including an operating system, and is programmed to carry out a variety of different processes.

In a variant of the preferred embodiment, the application layer processor 20 is programmed to process data using object-oriented techniques, and the storage device 24 stores data as instances of objects. Each piece of data processed by the application layer processor 20, including for instance pieces of HTML code; extraneous characters; web pages; database entries such as rows, columns or cells; requests for data, including requests for web pages or requests for database data is processed as an object. If a piece of data is not in the form of an instance of an object then the application layer processor 20 generates an instance of object which represents or contains that piece of data. The application layer processor 20 also establishes and manages the relationship between all objects.

The use of the application layer processor 20 in one particular data processing task, inserting extraneous characters into HTML or other code, is now described.

The server 2 is connectable to a network, and is shown in FIG. 1 as being connected to the internet. The server is adapted to transmit data across the network in response to a request for the data from a client device.

In the arrangement illustrated in FIG. 1, the client devices are web browsers 4 6 8 and transmission of requests from the web browsers 4 6 8 to the server 2 and the transmission, in response, of respective data from the server 2 to each web browser 4 6 8 via the internet 10 is shown schematically by arrows.

A large number of different client devices are able to connect to the server 2 via the internet and the three web browsers 4 6 8 are shown in FIG. 1 purely by way of example.

In operation, a request for data, or other message, from the internet 10, and originating for instance from one of the web browsers 4 6 8, is received at the transport and network layer processor 22. The transport and network layer processor 22 passes the request for data, or other message, to the application layer processor 20. The application layer processor 20 processes the request for data, or other message. In the case of a request for data, the application layer processor 20 retrieves data from the storage device 24, processes the data, and passes the processed data to the data modification module 30. The data modification module 30 then passes the processed data to the transport and network layer processor 22 for onward transmission across the internet 10 to, for instance, the web browser from which the request for data originated. Alternatively, the application layer processor 20 sends a request to the storage device 24 which causes the storage device 24 to send the data directly to the data modification module 30 or directly to the transport and network layer processor 22, for onward transmission.

The data, and the request for data, is sent between the server 2 and the web browsers 4 6 8 using a layered data structure in which a network protocol, such as internet protocol (IP), is used to split the data into a number of separate packets. In order to establish communication between the server 2 and the web browsers 4 6 8, and enable the sending of the separate data packets, a transport protocol is used, such as UDP or TCP.

The transport and network layer processor 22 is programmed to receive data from the application layer processor 20 and to split the data into IP packets including appropriate IP headers. The transport and network layer processor 22 is also programmed to establish communication with the appropriate client device, in the example shown a web browser 4 6 8, using UDP or TCP, to add appropriate UDP or TCP headers to the IP packets and to send the IP packets to the client device.

The transport and network layer processor 22 is also programmed to establish communication with a client device via a network, for instance the internet, upon request of a client device, for instance a web browser 4 6 8. The transport and network layer processor 22 is programmed to then receive data or requests for data from the client device via the internet, typically in packet form, to remove headers from the packets and to recombine the packets so as to form the data or the request for data sent from the client device, and to pass the resulting data or request for data to the application layer processor 20.

In the preferred embodiment the data, or the request for data, can be in any of a range of different application protocols and the application layer processor 20 is programmed to be able to process any of a range of different application protocols.

In relation to the insertion of extraneous characters, in particular, the application protocols include, for instance, mark-up languages or tag-based languages, such as SGML, XML, HTML, XHTML, or RSS.

Considering the application layer processor 20 in more detail, it can be seen in FIG. 2 that the application layer processor 20 includes a data processing module 26 and a security module 28.

In operation, the data modification module 30 is programmed to modify data from the data processing module 26 or from the storage device 24. The data modification module 30 then passes the modified data to the transport and network layer processor 22.

The data modification module 30 operates in dependence on operation of the security module 28. The security module 28 determines whether the data modification module 30 modifies data to be sent to the transport and network layer processor 22 or whether the data is sent without modification.

The operation of the data processing module 26, the data modification module 30 and the security module 28 is now described in more detail.

The data processing module 26 is programmed to carry out any of a variety of processes on data or a request for data received at the application layer processor 20, or in response to data or a request for data received at the application layer processor 20.

In a simple example, the data processing module 26 receives a request via the transport and network layer processor 22, identifies that data to be sent in response to the request is located in the storage device 24, retrieves the response data from the storage device 24 and sends the response data to the transport and network layer processor 22 via the data modification module 30. In that example, if the request is a request for a web page then the data processing module 26 identifies that the HTML code which can be used to generate the web page is located in the storage device 24, retrieves the HTML code from the storage device 24 and sends the HTML code to the transport and network layer processor 22.

In another example, the data processing module 26 receives a request via the transport and network layer processor 22, generates the data to be sent in response to the request and sends the response data to the transport and network layer processor 22 via the data modification module 30. In generating the response data, the data processing module 26 may in some circumstances use data from the storage device 24. In that example, if the request for data is a request for a web page then the data processing module 26 generates on the fly HTML code which may be used to generate the web page. In that case, the data processing module 26 may use data from the storage device 24, in the form for instance of a web page template or text data to be displayed on the web page, in generating the HTML code.

The data modification module 30 is arranged to modify data before the data is sent to the transport and network layer processor 22.

The data modification module 30 in the preferred embodiment is programmed to insert extraneous characters into the data and, in particular, to insert extraneous characters into computer code included in the data.

In one mode of operation, the data modification module inserts extraneous characters into HTML code representative of a web page. The insertion of the extraneous characters is such that the HTML code with the extraneous characters inserted can be processed by a web browser, without having any effect on the display of the web page which the HTML code represents. However, the extraneous characters are such as to affect operation of a pattern recognition process on the HTML code, such as that applied by a web browser.

Each feature present on a web page has certain display characteristics and may also have text data, which may include numerical data, associated with it.

So, for example, each web page feature may have certain display characteristics such as size, shape, position within a window, background colour, border colour, font, font size, and font colour, each of which is determined by an attribute within an HTML tag or tags, and an associated value of the attribute. Many web page features also include output data such as text data which is displayed on the web page (for instance entries in a table). The output data, for instance text data, also appears within the HTML tag or tags.

The data modification module 30 is programmed to insert the extraneous characters at locations within HTML tags, and to insert extraneous characters which resemble attributes of the tag and which, if later not recognised by a compiling engine, for instance included in a web browser, are simply ignored by the compiling engine.

The extraneous characters may be inserted at any location within HTML tags, or any other code location where they will be ignored by a compiling engine, included for instance in a web browser, and thus where their presence would not change the visible display (for instance the appearance of a web page) for the user.

The extraneous characters are located with reference to a target point or a set of target points within the HTML code. The target points can be, variously, start tags, end tags or commands.

Typically the target point or set of target points for HTML code representative of a web page are selected during a set-up procedure. The target points are either selected by a user or selected automatically based on a set of pre-defined rules. In variants of the preferred embodiment, the target point or set of target points is generated on the fly during the data modification process.

In the preferred mode of operation, the extraneous characters and their location relative to a set of target points is varied by the data modification module 30. In particular, each time a piece of code is requested from the application layer processor 20, the data modification module 30 changes the extraneous characters inserted in the code and their location relative to the target point or the set of target points.

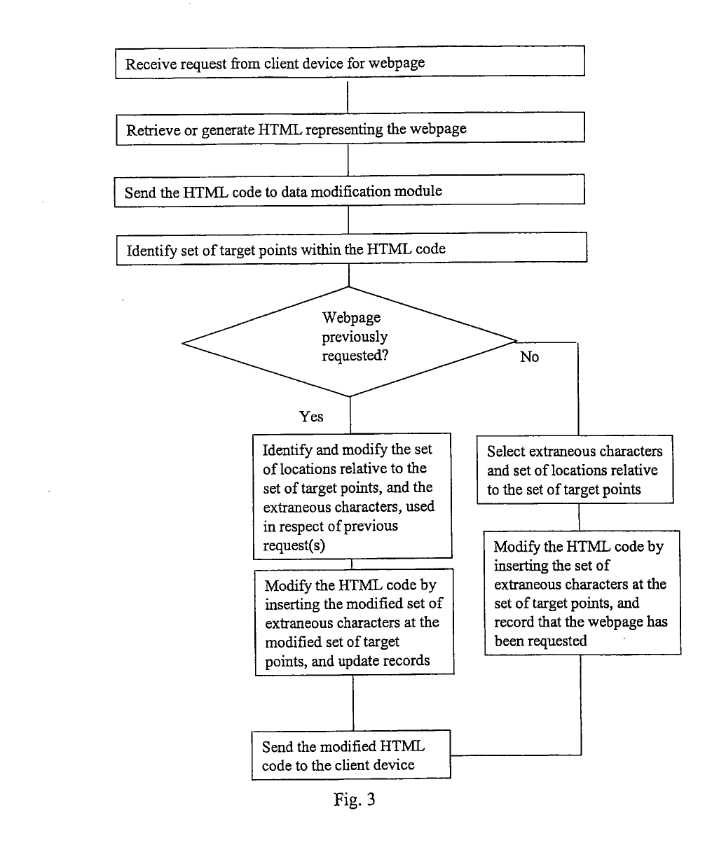

A flow chart illustrating in overview operation of the system is provided in FIG. 3.

Operation of the data modification module 30 is illustrated in the following example.

A piece of HTML code representative of a table cell is as follows:—

<td bgcolor=“red” align=“center”>DATA TO EXTRACT</td>

The piece of HTML code is stored in the storage device 24, and upon request of the piece of HTML code by the application layer processor 20 (for instance in response to a request for a web page which includes the table cell) the piece of HTML code is sent from the storage device 24 to the application layer processor 20.

The piece of HTML code is then passed to the data modification module 30, which identifies the target points of the piece of HTML code.

In the present example the target points are the commands bgcolour=“red” (which sets the background colour of the cell to be red) and align=“center” (which aligns the contents of the cell in the centre of the cell). The DATA TO EXTRACT portion is representative of output data, in this case text data, included within the HTML command. If the table cell command were to be executed the text DATA TO EXTRACT would be displayed in the table cell.

The data modification module 30 generates extraneous characters. In this case the extraneous characters resemble an attribute of the tag (extraneousPattern) together with an associated value of the attribute (123456UHJTG*****%%%%%) made of a random, or quasi-random, series of alphanumeric characters. The sequence of extraneous characters is extraneousPattern=“123456UHJTG*****%%%%%”.

The data modification module 30 then applies an algorithm to determine where in the HTML code the extraneous characters are to be inserted, relative to the target points. In this case, the data modification module 30 determines that the extraneous characters should be inserted immediately after the “align=center” target point, and inserts the extraneous characters at that point to produce a modified piece of HTML code:—

<td bgcolor=“red” align=“center”
extraneousPattern=“123456UHJTG*****%%%%%” >DATA TO
EXTRACT</td>

The piece of modified HTML code is then sent, together with other modified HTML code representative of the web page, from the data modification module 30 to the transport and network layer processor 22 for onward transmission, for instance to a web browser which requested the web page.

In subsequent processing of the modified HTML code, a web browser would not recognise the extraneous characters which resemble an attribute of the tag as being a genuine attribute of the tag and would ignore the extraneous characters in processing the modified HTML code.

If a further request by the application layer processor 20 is received subsequently at the storage device 24 for the piece of HTML code (for instance arising from a further request for web page which includes the table cell), the piece of HTML code is again sent from the storage device 24 to the application layer processor 20, and then to the data modification module 30.

Again, the data modification layer module 30 identifies the target points of the piece of HTML code, generates further extraneous characters, determines insertion positions relative to the target points and inserts the extraneous characters at the insertion positions.

In this case, the extraneous characters again resemble an attribute of the tag (mypattern) together with an associated value of the attribute (***&&&77709UYTRE£$), and the insertion position is determined as being immediately after the bgcolour=“red” target point.

The modified HTML code is thus as follows:—

<td bgcolor=“red” myPattern=”***&&&77709UYTRE£$”
align=“center” > DATA TO EXTRACT</td>

Again the modified HTML code, together with other modified HTML code representative of the requested web page is sent from data modification module 30 to the transport and network layer processor 22 for onward transmission, for instance to a web browser which requested the web page.

If a further request by the application layer processor 20 is received subsequently at the storage device 24 for the piece of HTML code (again, for instance, arising from a request for web page which includes the table cell), the same procedure is followed and the data modification module 30 produces modified HTML code as follows:—

<td yourPattern=“09HUY988767TYUIGHI” bgcolor=“red”
align=“center” > DATA TO EXTRACT</td>

In that case the extraneous characters are yourPattern=“09HUY988767TYUIGHI” and are inserted immediately before the bgcolour=“red” target point.

In the example described above, consideration has only been given to the modification of a single piece of HTML code representing a table cell, upon request for HTML code representing a web page in which the table cell is included. The table cell is only a single part of the web page and there would be many other pieces of HTML code representative of other parts of the web page which would be sent from the storage device 24 to the application layer processor 20. The other pieces of HTML code would also be subject to modification by the data modification module 30 with, in each case, other extraneous characters being inserted in respective insertion positions.

Furthermore, in the example described above, in each case extraneous characters have been inserted in only one insertion position for the piece of HTML code, and the extraneous characters comprise a portion resembling an attribute for an HTML tag and a portion resembling a value for the attribute. In alternative modes of operation, extraneous characters are inserted in more than one insertion position for a piece of HTML code, or are not inserted. Also, the extraneous characters may be in a different form such as, for instance, a random sequence of alphanumeric characters.

The security module 28 is linked to operation of the data modification module 30 and operation of the security module 28 determines whether the data modification module 30 modifies data before sending it to the transport and network layer processor 22.

In one mode of operation the security module 28 is programmed to request a password from a client device in response to a request from a client device. In particular, the security module 28 is programmed to request, via encrypted transport protocol, a password when a communication session is opened with a client device, and if the correct password is provided then data is subsequently provided to the client device without being altered by operation of the data modification module 30.

In another mode of operation the security module 28 obtains from the transport and network layer processor 22 the identity of the client device, for instance in the form of a MAC address, and compares the identity of the client device to stored identification information. Depending on the comparison, data is subsequently provided to the client device either with or without being altered by operation of the data modification module 30.

The security module 28 has been shown as being located within the application layer processor 20 in the preferred embodiment. In alternative embodiments the security module 28 is separate from the application layer processor 20 and/or is included in the data modification module 30.

Furthermore, in alternative embodiments the data modification module 30 is separate from the application layer processor 20.

In alternative modes of operation, data is sent from the storage device 24 directly to the data modification module 30, without being sent via the application layer processor 20. Alternatively the data is sent directly, and without modification, from the storage device 24 to the transport and network layer processor 22.

The effect of extraneous characters inserted into HTML code by the data modification module 30 on operation of a web scraping process is now described.

It is known for a web browser 6 to include, or be associated with, a web scraping processor. If such a web scraping processor is present then the HTML code at the application layer of the browser is passed to the web scraping processor as well as, or instead of, being processed at the application layer of the web browser to generate display data.

The web scraping processor applies a pattern recognition process to the HTML code in order to extract text data which is intended for display on the web page. Such a pattern recognition process typically operates by applying a set of rules to the HTML code which reflect where in a portion of HTML code text data intended for display is likely to appear.

So, for instance, it may be expected that text data may be displayed in a table, and in that case the web scraping processor would, for instance, be programmed to apply a pattern recognition process to the HTML code to identify the tags relating to a table, or to a table cell.

In one example, HTML code for a table cell of a table included in a web page is as follows:—

<td bgcolor=“red” align=“center”>£100</td>

In that case, the web scraping processor identifies the start and end tags <td and /td> and uses a pattern recognition process to identify that between such tags data to extract may appear after, for instance, bgcolor and align commands defining the background colour and alignment of the cell.

In this example, the web scraping processor is then able to extract the text “£100” from the HTML code.

Typically the web scraping processor also extracts text from other pieces of HTML code representative of other parts of the web page, and then passes the extracted data for storage, or further processing. The extracted data is often displayed on another web page, associated with the web scraping processor.

The extraneous characters inserted into HTML code by the data modification module 30, as described above, have the effect of interfering with operation of a web scraping processor. The presence of the extraneous characters can either prevent extraction of data from the HTML code or ensures that data extracted includes extraneous characters as well as desired data making the extracted data effectively unuseable for many purposes.

For instance, in the case where extraneous characters inserted into HTML code comprise a portion resembling an attribute for an HTML tag and a portion resembling a value for the attribute, the extraneous characters can cause a web scraping processor to extract data from the wrong point in the HTML code, or to not extract data at all.

Alternatively, if the extraneous characters comprise a random, or quasi-random, series of alphanumeric characters then the extraneous characters can cause a web scraping processor to extract some or all of those characters, in addition to desired data. For many purposes that can make the extracted data effectively unuseable.

The variation of the extraneous characters and their location by the data modification module 30 also has the effect of interfering with operation of the web scraping processor, as it prevents the web scraping processor learning the location and nature of the extraneous characters over time.

The data modification module 30 is programmable, to enable additional algorithms relating to the nature and location of extraneous characters to be operated by the data modification module 30. Thus as new pattern recognition techniques are used by web scraping processors, additional algorithms can be provided to the data modification module 30 to counteract those new pattern recognition techniques.

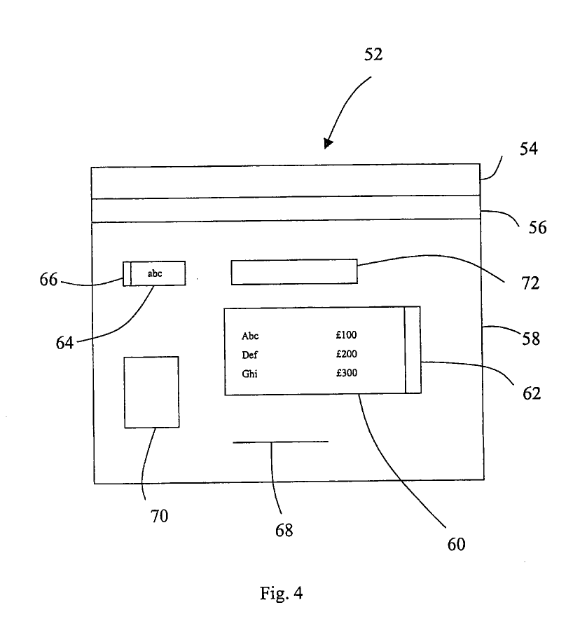

An example of a web page generated using HTML is shown schematically in FIG. 4, in order to illustrate some examples of text which may be extracted by a web scraping processor and associated web page features.

The web page is displayed in a window 52 displayed on a computer screen (not shown), the window 52 including a toolbar region 54, an address region 56 which displays the address of origin of the web page, and a display region 58 in which the web page is displayed.

The web page includes a table 60 in which text data, including numerical data, is displayed (“abc”, “def, “ghi”, “£100”, “£200”, and “£300”) and an associated scroll bar 32.

The web page also includes a drop-down menu 64 and an associated button 66. Text data representing the current selected item is shown in FIG. 4. The features also include a hypertext link 68, a video display window 70 in which streaming video can be displayed, and a text entry box 72 into which text can be entered by a user.

Text data which may be extracted by a web scraping processor is associated with each of the table 60, the drop-down menu 64, the hypertext link 68, and the text entry box 72. In the preferred embodiment, the data modification module 30 operates to insert extraneous characters in the HTML code used to generate the table 60, the drop-down menu 64, the hypertext link 68, and the text entry box 72 in order to interfere with operation of a web scraping processor.

In each of a variety of alternative embodiments the functions of the data processing module 26, the security module 28, the data modification module 30, are provided in respective one a wide variety of different system architectures, in either software or hardware.

In particular, in alternative embodiments, functions of the data processing module 26, the security module 28 and the data modification module 30 which enable insertion of extraneous characters are provided using a non-object oriented approach. In one alternative embodiment, the functions of the data processing module 26, the security module 28 and the data modification module 30 which enable insertion of extraneous characters are provided in a suitably programmed standard web server.

### Object Oriented Features

In the embodiment described above, the application layer processor is used to carry out processes on data in order to prevent or control web-scraping. In the preferred embodiment of another, closely related aspect of the invention the application layer processor is arranged to carry out any of a wide variety of different processes using object oriented techniques, and forms part of an object oriented data processing system. In the preferred embodiment of that aspect of the system, the object oriented data processing system is a fully object oriented enterprise software platform.

In particular, the system is a fully web-based development platform which can be used to provide a full set of web-based services for every kind of business—without the need to employ significant amounts of developer resource.

Within the system, the properties and functionality assigned to data are always assigned within the context of a data hierarchy. Typically, all pieces of data are either a ‘parent’ or a ‘child’ and the properties and functionality of all data can be changed/reassigned other properties/functionality at will.

The system provides users with a screen-based interface (GUI). The GUI allows the user to perform all tasks via intuitive drill down menus, easy to follow instructions and click, drag and drop functionality which are object based—and do not require the skills of developers or programmers when in use.

The GUI provides users with the ability to build and manage various applications, including by way of example:

1) Handling legacy data (including selection, extraction, integration, management and export) and creation of new databases

2) Managing content (CMS applications) including creation of portals and websites

3) Managing customer relationships (CRM applications)

4) Managing assets (AM applications)

5) Tracking and reporting (T&R applications).

The particular applications listed above are described in more detail below. Firstly, the structure and operation of the system in the preferred embodiment are described.

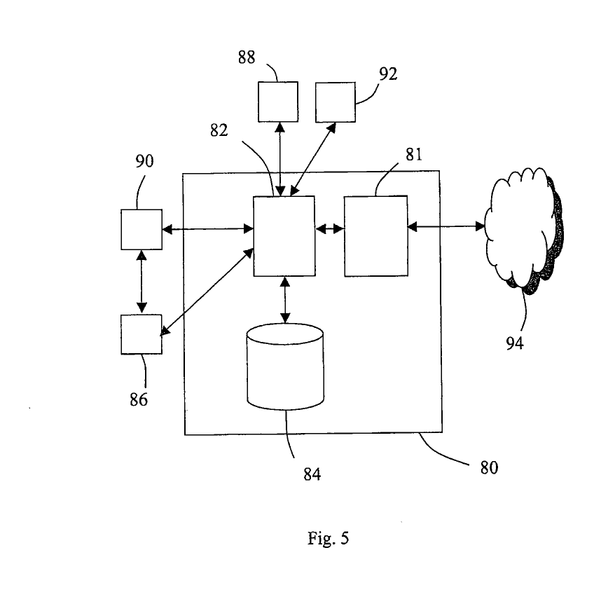

FIG. 5 shows the structure of an embodiment of the system, which includes a server arrangement 80. The server arrangement 80 includes an application server 81 and a database server 82 and a memory in the form of RAM 84, connected to the database server 82. The server arrangement 80 is connected to a further memory 88, which is arranged so that data can be transmitted between the application server 81, the database server 82 and the further memory 88. The processor is also connected to a display 90 for displaying information to a user, and to a user input device 86, for instance a mouse and/or keyboard.

The server arrangement may be connected to a variety of external data stores, of a variety of different types. For the purposes of illustration, a single such external data store 92 is shown in FIG. 5. The application server 81 is connected to the internet 94.

In the preferred embodiment, each of the application server 81 and the database server 82 runs Windows Server Operating System. The two servers are connected inside a LAN (local area network).

The application server 81 is connected to the Internet via a router or modem or directly via communication networks. The application server 81 has the following software running on it (in addition to the Windows Server OS): Java Virtual Machine 1.5, JSP server (such as Tomcat, JBoss, Websphere, Jrun etc) and the system's application code.

The database server 82, which is connected to the application server 81, has a database package (such as Oracle or SqlServer) installed on top of the Windows Server Operating System.

### Database Tables

The further memory 88 stores a plurality of database tables. Typically, in the preferred embodiment, the further memory 88 stores twenty or fewer database tables.

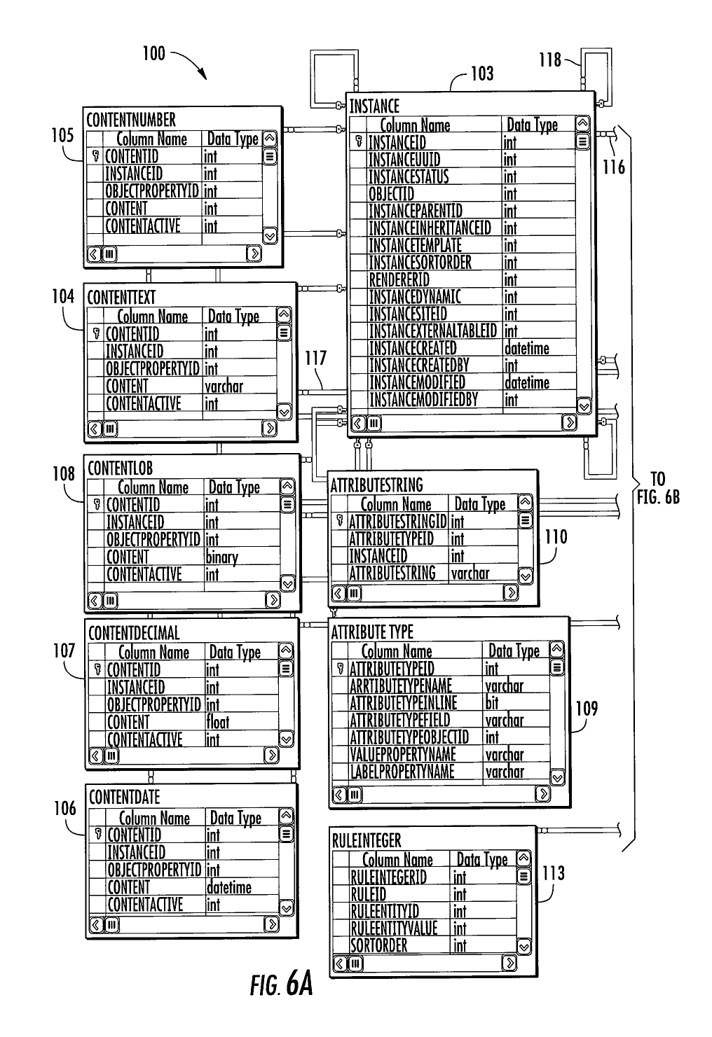

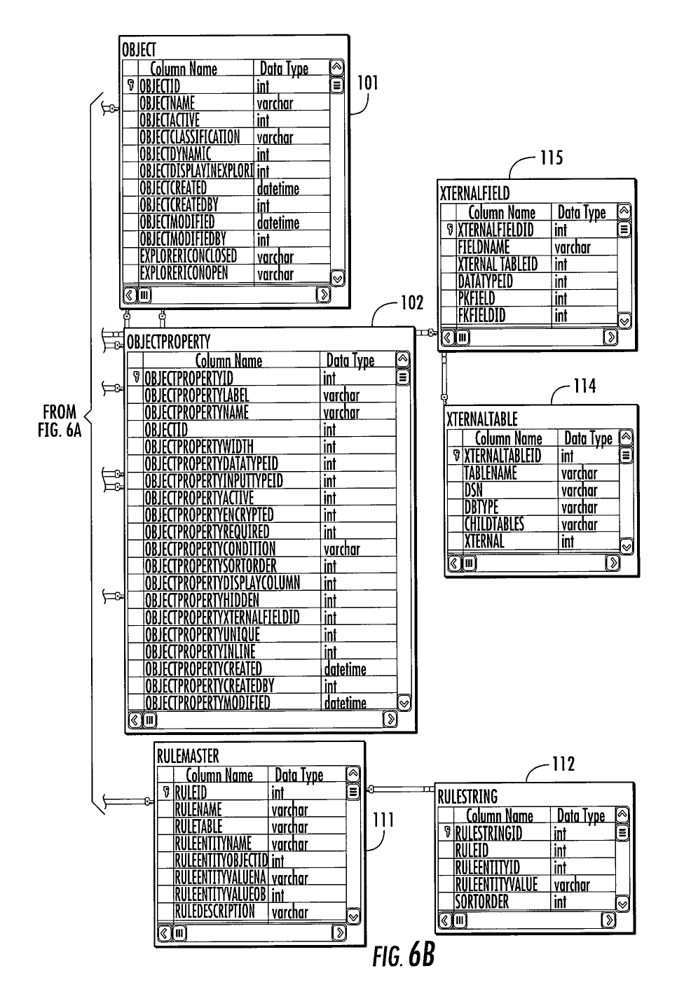

The database tables 100 in the preferred embodiment are shown schematically in FIG. 6, and make up a processing module.

Each database table comprises various fields, arranged in columns, each of which contain data of a specified type. The fields for each database table are listed under the column headings Column Name in FIG. 6.

The various tables are interlinked and, typically each table entry comprises one or more of data, process information, and links to other entries in the table or in other tables or links to external data or processes.

The database tables include objects, instances of objects, rules, executable programs and data or links to data, which alone or in combination may form sub-modules, and which are interlinked so as to provide a self-contained data management, processing and display system. The database tables include executable system objects which cause the display of a GUI via which a user can manage the management, processing and display of data. The user can also, via the GUI, manage and alter the operation of functionality of the system itself, and of the GUI itself, by adding, editing and changing the relationships between entries in the database tables and in particular between objects, instances, and data stored in the database tables.

By providing a GUI with which the user can create, manage and change the relationships between objects, instances and data, the user is able to develop and operate his own object-oriented applications.

The database tables are:
Object 101
ObjectProperty 102
Instance 103
ContentText 104
ContentNumber 105
Content Date 106
Content Decimal 107
ContentLob 108
AttributeType 109
AttributeString 110
RuleMaster 111
RuleString 112
RuleInteger 113
XternalTable 114
XternalField 115

Before considering further the functionality of the system, each of the database tables is considered in turn.

Objects and their properties are persisted in tables “Object” 101 and “ObjectProperty” 102. These two tables are linked via ObjectId field present in both of them and their relationship is one (Object) to many (ObjectProperty).

Instances of objects are stored in the table “Instance” 103, linked to the table Object 101 via the field ObjectId. The relationship is one (Object) to many (Instance).

Instance content is stored in one of the Content tables (ContentText 104, ContentNumber 105, ContentDate 106, ContentDecimal 107, ContentLob 108) and is linked to instances via the field InstanceId (present in all tables). The relationship is one (Instance) to many (Content).

Content is also linked to ObjectProperty table 102 via the field ObjectPropertyId (present in all Content tables 104 105 106 107 108). The relationship is one (ObjectProperty) to one (Content). Thus, each object property stores a single piece of data of an instance on the system.

Rules and behaviours of Objects, ObjectProperties and Instances is determined in RuleMaster 111, RuleInteger 113 and RuleString 112 tables.

Instance attributes are stored in AttributeType 109 and AttributeString 110 tables.

Links to external content such as legacy databases are stored in tables XternalTable 114 and XternalField 115.

Primary key links (for instance link 116 between the Object table 101 and the Instance table 103) and links between other tables (for instance the link 117 between the Instance table 103 and the ContentText table 104) are also shown schematically in FIG. 6.

The database tables are relational database tables and are linked via primary keys and foreign keys. Primary keys are unique identifiers of the “one” record in “one-to-many” relationships, while foreign keys are the presence of that same primary key in “many tables”. So, for example, we could have a care provider with an i.d. of, say, 14 and because no other provider could ever have the same i.d., it is called a “primary key”. This primary key (14) would appear as part of any Home records linked to that provider. This is how this “relation” between one and many is created in relational databases. A database table can also have a primary key link to itself. An example is Instance table where instanceId (primary key) is connected to instanceParentId, thus creating a relationship between instances themselves (making some of the links parents of other instances).

### Objects

Each object stored in the database tables comprises a set of attributes which define the properties of an object, the way the object interacts with other objects, and any processes which may be carried out by the object. Typically each entry in the database tables which represents an object comprises a mixture of data and links to other objects or data within the tables.

The system objects are those objects which relate to the basic operation of the system and which manage processes carried out by the system and processes relating to interaction with a user.

Object instances are the content of objects and their properties. Typically each entry in the database tables which represents an instance of an object comprises a foreign key link to a corresponding entry in an object table, and also comprises data which determines the values of the various properties of the object and/or also comprises links to content tables which serve to populate the values of the various object properties of the object with data stored in the content tables.

### Data Storage

There are three ways to store and manage data in the preferred embodiment:

1) Meta-Data stored in Content tables 104 105 106 107 108, linked directly to instances and object properties. Usually only system data such as, for example, Users, User groups Renderers, Languages, Data Types, CSS Style commands, HTML tag attributes are stored inside the meta-data storage.

2) Business data stored in typical RDBMS tables which are automatically created upon object creation and linked to objects, object properties and instances via XternalTable 114 and XternalField 115 tables. These RDBMS tables are automatically created and managed via a graphical user interface (GUI), without any manual input by the user. Business data is stored inside of them and easily accessible by the external and third-party tools, such as reporting tools.

3) Existing, legacy, external databases, linked to objects, object properties and instances via XternalTable 114 and XternalField 115 tables and link tables. These legacy tables are pre-existing parts of old, legacy systems, linked to objects and easily integrated with Meta-Data or new business data.

### Rules

Three of the database tables (RuleMaster, RuleInteger and RuleString) in the preferred embodiment store rules. The rules define the default behaviour of the various system objects and their instances.

Examples of rules stored in the database tables include ObjectContainerRule which determines which objects can contain which objects in the parent-child hierarchy (for example, an HTML table object can contain HTML table row object, but not HTML table cell object, while HTML table row object can contain HTML table cell object, but not HTML table object), ObjectRendererRule which determines which rendering functions are used to render which objects, ObjectStyleRule which determines which CSS style commands are applicable to which HTML objects, ObjectDSNRule which determines whether an object is linked to an external data source. Other rules define the default behaviour of all of the other system objects and their instances.

### Content and Object Instances

Some of the database tables 104 105 106 107 108 store content. The content is data which forms part of objects or instances of objects. Table entries for particular instances of objects usually link to corresponding table entries in the content tables 104 105 106 107 108, and the content from those table entries populates instances of objects. Database tables 104 105 106 107 108 are not the only database tables which store content of instances. For instance, a relational database RDBMS table for each dynamic object is automatically created. Such RDBMS tables for dynamic objects are dynamically destroyed and created as objects are deleted or added to the system.

The content may be text, numerical, date/time or binary data. Typically the content is data relating to the activities of a user. So, by way of example, if the system is used by a manufacturing business, the content may include product specification data, price data, customer names and addresses, customer payment records, supplier names and addresses, supplier reliability data, sales figures, and shipping information.

In that example, one of the objects present in the object tables represents products. The attributes of the product object in the example are product name, product specification, sales figures, and names and addresses of customers who have bought the product.

An instance of the object product represents a particular product. The entry in the instance tables representing the instance of the object product comprises links to entries in the content tables which contain data representative of the name of that product, the specification of the product, sales figures for that product, and names and addresses of customers who have bought that product.

The object in that example is a dynamic external object, as it relates to user data and is stored within the external RDBMS within the set of database tables.

The same user data as mentioned in the preceding example may also be stored in an external legacy database rather than in a external RDBMS (however, the external legacy database may also be of the type RDBMS). In that case, the instance of the product object contains links to entries in the external database table rather than to entries in a content table of the set of database tables.

It is a feature of the system that dynamic internal objects and dynamic external objects can be used interchangeably. So, for instance, the user is able to instruct the copying of data from an external database to the content tables of the set of database tables and to alter the links in the corresponding instance entry or entries in the database tables.

### System Objects

The database tables stored in the further memory 88 include a base set of objects, also referred to as the system objects, and rules which interact to provide a self-contained data processing system which is operable by the processor to generate a graphical user interface (GUI) for display to a user on display 90.

The base set of objects includes executable objects, which are executable by the processor to carry out certain processes.

The base set of objects and rules enable the user, for instance, to create further objects; edit and delete objects; create and manage relationships between objects; create, edit or delete instances of objects; and import data from external sources to populate the tables, the objects or the instances of objects by using the GUI.

The system objects are those objects which relate to operation of the system and which manage processes carried out by the system and processes relating to interaction with a user.

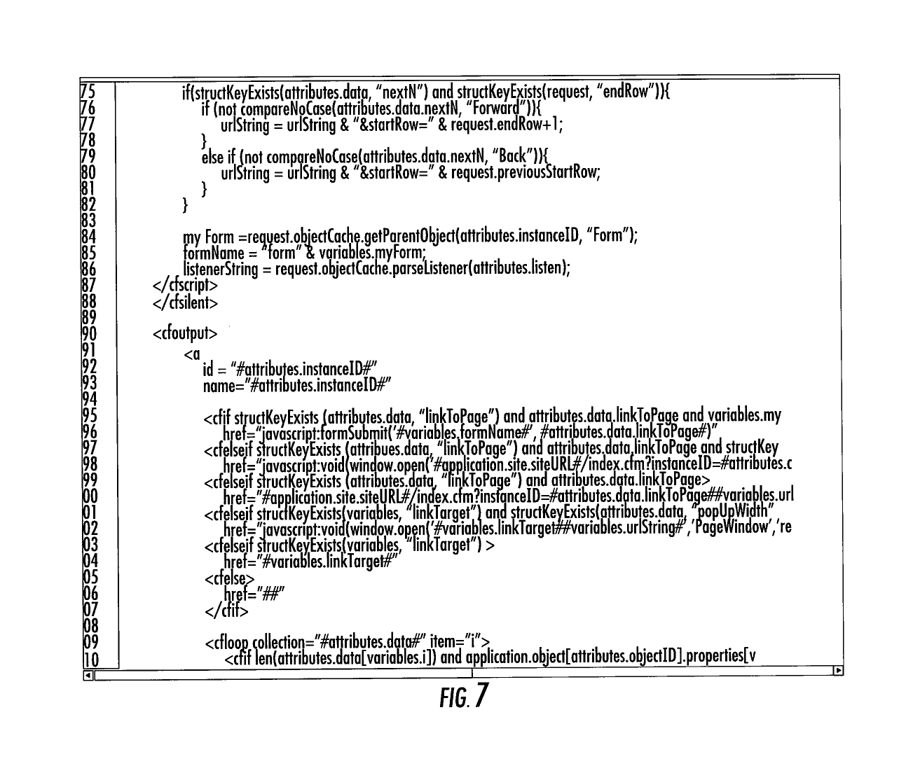

Examples of system objects include HTML table, HTML row, HTML cell, CSS style command, user, user group, user privileges, and object rendering functions. HTML system objects dynamically build web pages, CSS style commands format the web pages, users and user groups and user privileges determine which users and groups can view/add/edit/delete various parts of the system. Rendering functions render visual objects on the screen. Instances of all of these system objects can be viewed, added, edited and or deleted if these actions are allowed by the user privileges. The user privileges are determined by Administrators. Other system objects manage other processes carried out by the system and other processes relating to interaction with a user. An example of a programming tag for the system object Hyperlink is shown in FIG. 7.

Programming (custom) tags are pieces of code assigned to execution of instances of particular objects. Whenever an instance of a given object is encountered in the hierarchy of execution, such a tag is executed in order to display the instance of the object on the screen or to process the function of that instance. These tags, also known as renderers (because they render the data of the given instance on the screen) are associated either with objects (so each instance of the given object uses the same tag) or on the instance level, so each instance can be customised individually.

By providing the user with the ability to create and manage objects and instances of objects, and to link to external data sources, using the GUI, the system provides a data processing system which can be adapted by the user to carry out any process or set of processes desired by the user on any data set specified by the user, without any requirement for the user to carry out any manual programming.

The set of database tables provides a self-contained data processing system, in which a plurality of objects, either created by the user via the GUI, or being system or other objects forming part of the database tables upon start up, are interlinked, for instance in parent-child relationships.

### Operation of Object Oriented Features

In operation, upon initial execution of the system, the processor 82 carries out an initial set of processes, which includes:—
loading and processing the base set of objects and rules in accordance with a start-up process governed by a start-up object
copying the database tables from the further memory 88 to the RAM 84
generating the GUI on the display 90
entering a responsive state in which actions instructed by a user via the GUI are monitored and action is taken in response to those actions

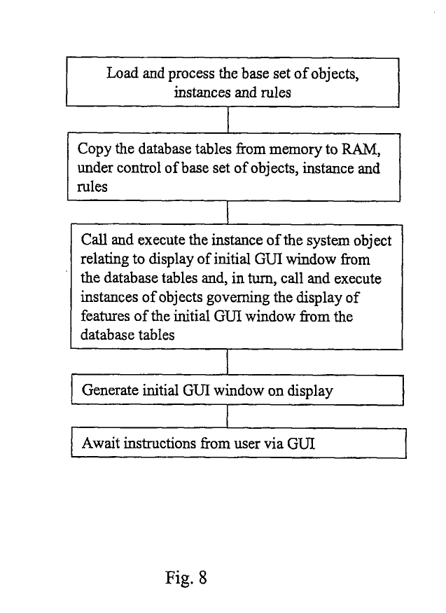

The initial set of processes which are carried out upon execution of the system are illustrated in the flow chart of FIG. 8.

Once the GUI has been displayed, actions can be instructed by a user via the GUI.

The processes that can be carried out by the user, via the graphical user interface, once the system has entered the responsive state following start-up include the following system processes.
Create Object (one off)
Create Object Properties (one off)
Add, Edit, View, Delete Object Instances (content and data management)
Display and/or Export of data

The system processes are governed by the base set of objects and rules.

Examples of various processes which can be carried out under the base set of objects and rules are described in more detail below.

The graphical user interface (GUI) is now described and the functionality of certain interlinked windows of the GUI is considered by way of example.

### Graphical User Interface

As mentioned above, upon start-up of the system the processor 82 processes the base set of objects and rules and displays the initial GUI window 119 on the display 90.

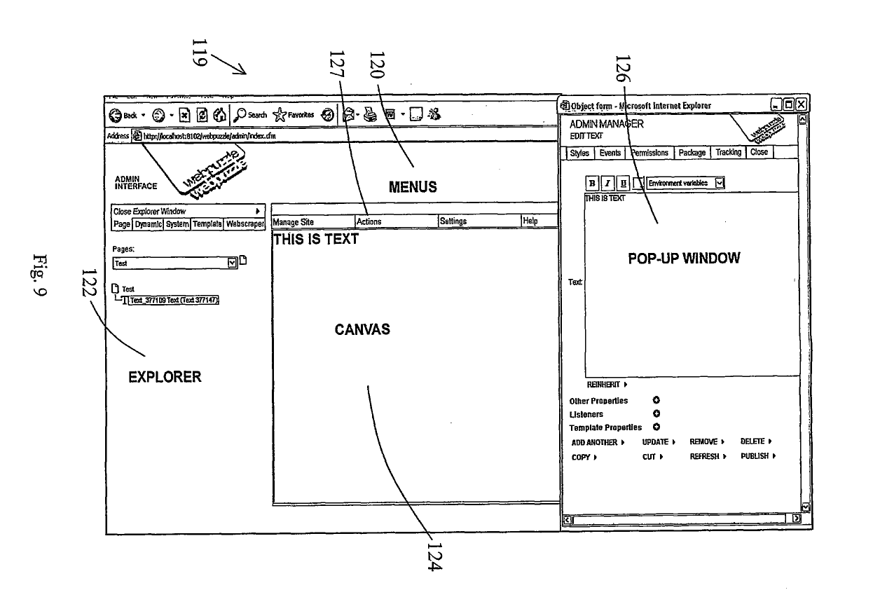

The basic layout of the initial GUI window 119 displayed upon start-up by a user with administrator privileges is shown schematically in FIG. 9. In normal use the various areas of the layout shown in FIG. 9 are populated with application-specific text or other data.

The GUI window 119 of FIG. 9 comprises four areas:
Menu 120
Explorer 122
Canvas 124
Pop-Up Window 126

Menu 120 is used for selecting functions (e.g. object creation, instance editing, publishing, etc).

Explorer 122 displays instance lists and hierarchies and is used for data searching and classification.

Canvas 124 displays the work in progress (e.g. a page a user is creating or editing) and/or data management windows (update, insert, delete).

Pop-Up Window 126 is the main management tool; it is used to edit, for instance, objects, instances and functions.

Various actions that can be taken by a user via the GUI are now considered. In accordance with the object-oriented, self contained nature of the system each GUI window is the result of execution of an instance of a GUI window object stored in the database tables. Each feature of each GUI window (for instance lists, boxes, clickable links) is in turn the result of execution of an instance of a respective object, with those respective objects being in a child-parent relationship with the GUI window object. The instance of the GUI window object includes links to instances of the other objects representing the features. Execution of the GUI window object instance causes the calling and execution of the linked instances of the other objects representing the features.

### Object Creation and Management Via the Object Manager Window

In order to create or edit an object, a combination of GUI tools is used.

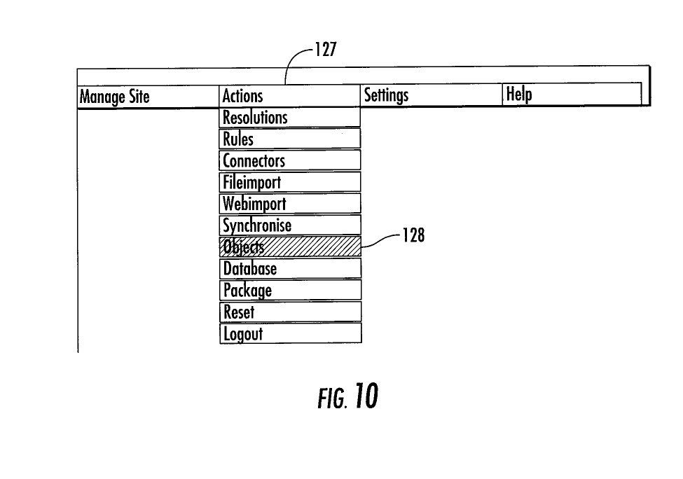

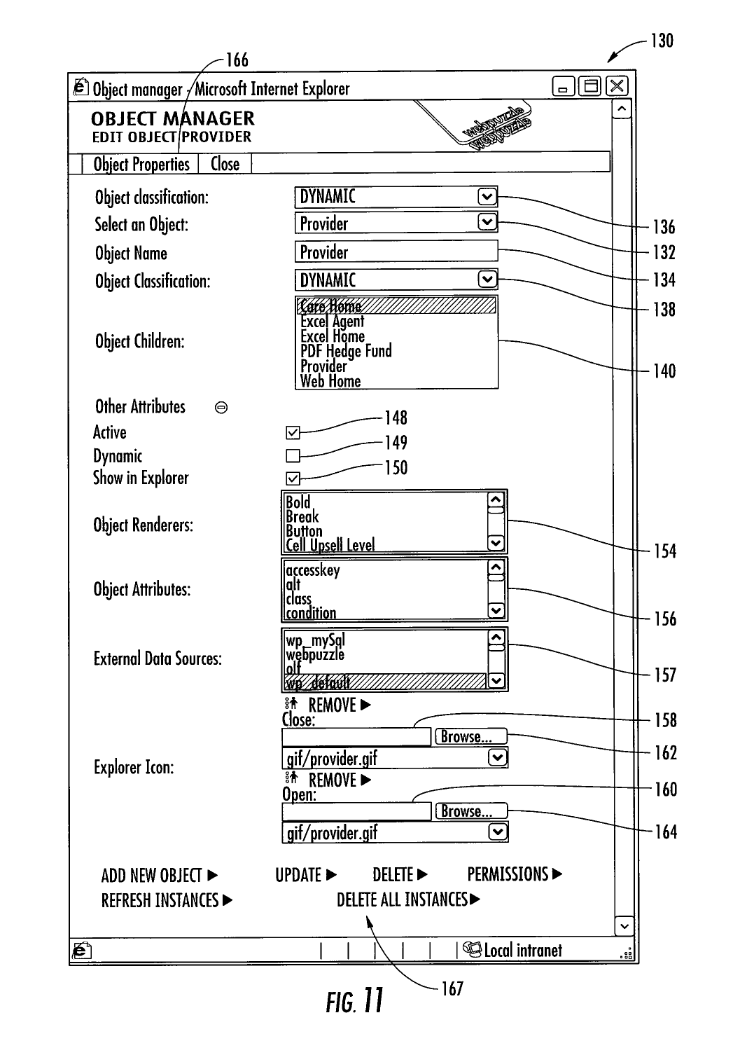

Firstly, the object editing function may be accessed by selecting the Objects item from a drop-down menu under the heading Actions 127 on the menus area of the GUI 120, as illustrated in FIG. 10. Selection of the Object item 128 causes the Object Manager pop-up window 130 to be displayed in the pop-up window area 126 of the GUI. The Object Manager pop-up window is shown in FIG. 11.

The Object Manager pop-up window 130 provides object management functions to the user. In particular, objects may be added, deleted or edited via the Object Manager pop-up window 130.

The Object Manager pop-up window includes a number of drop-down menus, tick boxes, and text entry boxes which can be used, for instance, to add, edit or delete objects.

In particular, the Object Manager pop-up window 130 includes a drop-down menu 132 which enables an existing object to be selected. The name of the selected object is displayed in text box 134. Other drop-down menus 136 138 enable an object type to be selected or changed.

A further menu 140 lists other objects which are in a child relationship to the selected object. The child relationship of any of the listed objects to the selected object can be removed by deleting that listed object from the list displayed in further menu 140. Thus, relationships can be created between a new or previously existing object and other objects, or relationships can be changed between a new or previously existing object and other objects by operation of the further menu 140.

A further set of three checkboxes determine the behaviour of the object:
ACTIVE 148 determines whether the object is active and available for processing. If checked, the object is active, if unchecked, it is inactive.
DYNAMIC 149 determines whether instances of the object can be cached in RAM, or must always be dynamically constructed at runtime. If checked, the instances will be constructed at runtime, if not checked, the instances can be cached in RAM.
SHOW IN EXPLORER 150 determines whether instances of the object should be included in the classification tree in the explorer part of the GUI. If checked, instances of the object will appear in the tree in the explorer, if unchecked, they will not.

A further menu 154 is used to determine the object renderers associated with the selected object. The object renderers determine which display functions are used to graphically render instances of the objects on a screen, if display of the instances is requested.

Another menu 156 is used to determine the object attributes associated with the selected object. The object attributes are common attributes for all instances of the object such as, for example, Language, Condition, Style.

Another menu EXTERNAL DATA SOURCES 157 is used to determine which data source the object link to for the external storage of data. All objects classified as DYNAMIC (objects which store business data) are linked to at least one external, RDBMS data storage by default.

Two text boxes 158 160 and associated buttons 162 164 are provided on the Object Manager pop-up window 130. The text boxes and associated buttons enable file locations to be entered or selected by browsing.

Further links 167 link to other pop-up windows which enable a user to add a new object, update the object which is the subject of window 130 (in this case the Provider object), delete objects, view and edit permissions, refresh instances of the object which is the subject of window 130 (in this case the Provider object), and delete all instances of the object which is the subject of window 130 (in this case the Provider object).

The example shown in FIG. 11 relates to a business application relating to care home provision (for instance for the elderly). The selected object shown in FIG. 11 is called Provider and represents care home provider or owner business object. The attributes, also referred to as properties, of the Provider object represent features of the Provider. Each instance of the Provider object represents a different care home provider.

It can be seen from FIG. 11 that the Provider is a Dynamic object. Instances of the object may be subject to change during operation of the system. The fact that the object is a Dynamic object is determined by the user, using GUI, when creating or editing an object, by setting the select list “Classification” to “DYNAMIC”. All dynamic objects are automatically treated as external objects and their instances and data are stored in external RDBMS tables. It can also be seen that the Provider object is a parent to a number of child objects. For instance, the Provider object is a parent to the Care Home object, which represents individual care homes. One of the attributes of the Provider Object is the name of the Provider. Similarly, one of the attributes of the Care Home object is the name of the Provider who owns the care home. As the Provider object is a parent to the Care Home object, any changes to an instance of the Provider object will be reflected in corresponding changes to the corresponding instances of Care Home objects. So, for instance, if the address of a particular care home provider changes, and the instance of the Provider object is amended by the user to reflect that change, the change of address will also occur automatically in the instance of the Care Home object representative of care homes owned by that care home provider.

Turning to consideration of the system objects associated with display of the Object Manager pop-up window 130, each of the drop-down menus, other menus, tick boxes, text entry boxes and buttons appearing on the pop-up window is displayed by execution of an instance of a respective system object stored in the set of database tables.

So, for instance, one of the system objects stored in the set of database tables is a menu object. A child object of that menu object is a drop-down menu object. Each of the drop-down menus 132 136 138 152 displayed on the Object Manager pop-up window is displayed by execution of a respective instance of the drop-down menu object.

The Object Manager pop-up window 130 itself is displayed by execution of an instance of a window object stored in the set of database tables. The attributes of the window object include, for instance, attributes which specify what menus, tick boxes, text entry boxes and buttons appear on the window. Each instance of a window object contains links to one or more of instances of menu objects, instances of tick box objects, instances of text entry box objects and instances of button objects. Execution of the instance of the window object causes, in turn, execution of the linked instances of menu objects, instances of tick boxes, instances of text entry boxes and instances of buttons, causing the window and menus, tick boxes, text entry boxes and buttons within the window to be displayed. The position, appearance and functionality of the menus, tick boxes, text entry boxes and buttons is determined by the values given to the various attributes of the window object, and the menu objects, tick box objects, text entry box objects and button objects.

The window object, and the instance of window object representing the Object Manager pop-up window 130, or any other of the objects and instances representing the GUI tools, or indeed any of the objects and instances of the system, may be edited using those GUI tools.

### Properties Management

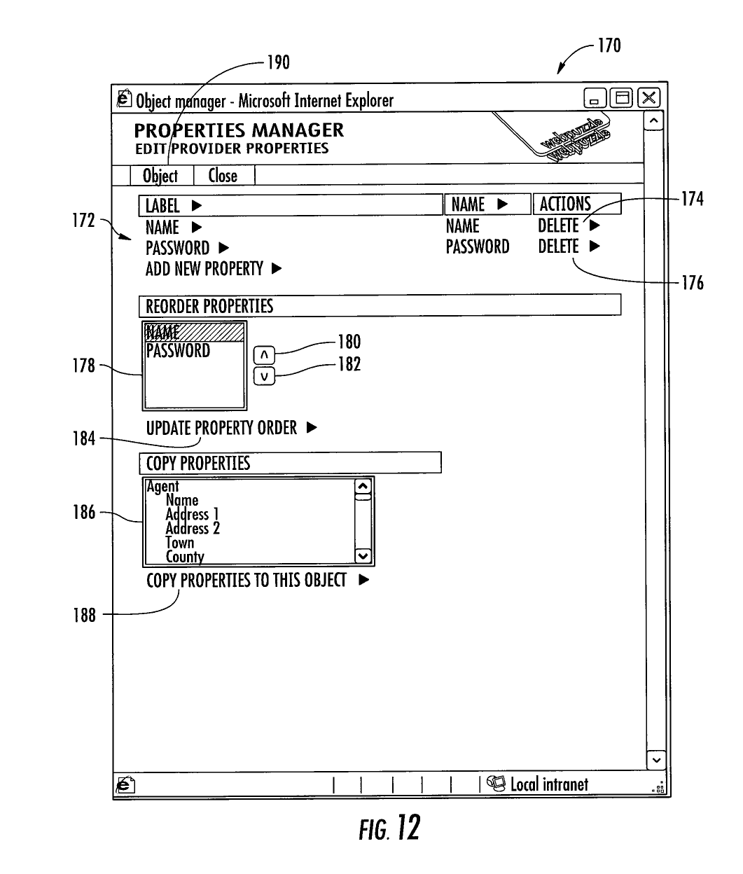

Returning to the functionality of the GUI, attributes of objects, also referred to as object properties, can be, for instance, listed, deleted, copied and reordered using the Properties Manager pop-up window 170 shown in FIG. 12. The Properties Manager pop-up window 170 is displayed upon selection of the Object Properties tab 166 shown in FIG. 11.

The Properties Manager pop-up window 170 enables the object properties of the object selected using the Object Manager pop-up window 130 to be listed, deleted, copied and reordered.

The object properties of the selected object are listed in an area 172 of the Properties Manager pop-up window 170. Each of the listed properties has a button 174 176 associated with it on the list. Operation of a button 174 176 causes the deletion of the associated property.

A list 178 and associated buttons 180 182 are provided which can be used to reorder the object properties. A button 184 is provided which can be operated to update the property order. Updating the property order affects the order in which they will appear when the Instance Creation and Editing window 250 is displayed.

A list 186 is also provided which lists other objects, together with an associated button 188. Objects may be highlighted on the list 186 and if the button 188 is then operated the properties of the selected object are copied to the highlighted object, so that the highlighted object then includes those properties.

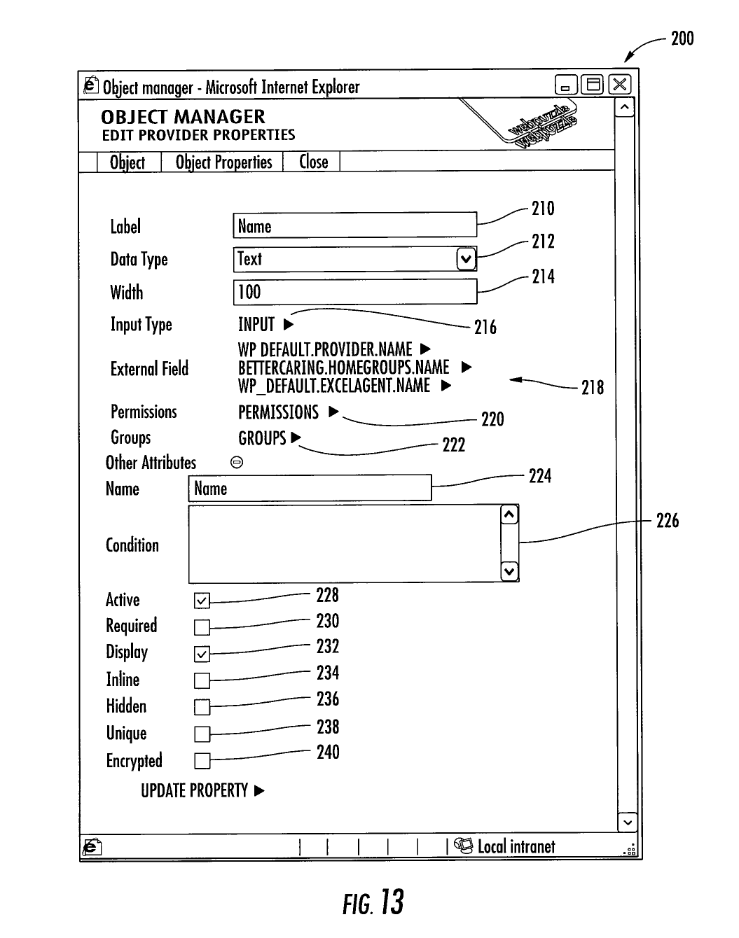

The Properties Manager pop-up window 170 shown in FIG. 12 also includes a button 190 which links back to an Object Manager window shown in FIG. 11. All of the property labels 172 are links to the Property Creation and Editing window 200. If any of those links is clicked the Property Creation and Editing window 200 in FIG. 13 replaces the window shown in FIG. 12. The Property Creation and Editing window 200 is used to edit fields in the database table ObjectProperty (unless indicated differently).

### Property Creation and Editing

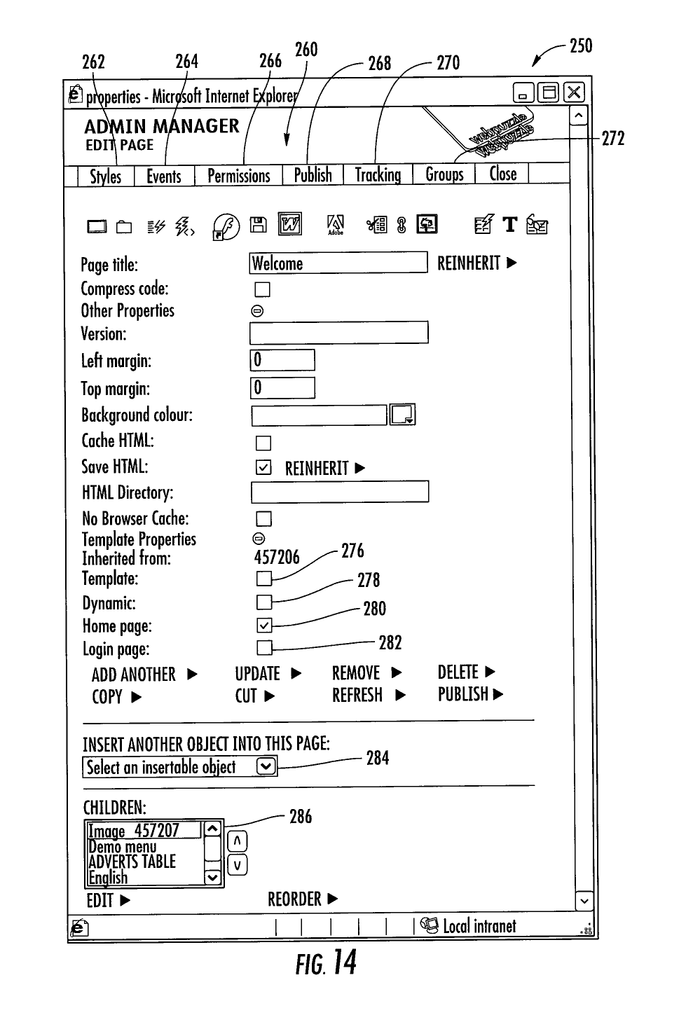

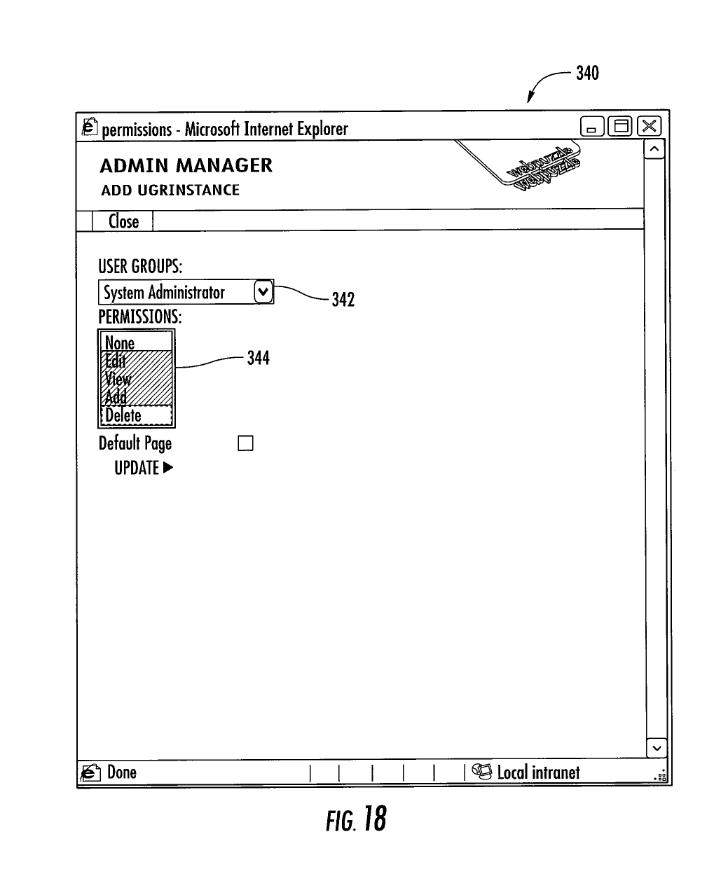

The Property Creation and Editing window 200 shown in FIG. 13 includes the following features:
A text input field LABEL 210 which is used to add/edit the display label of the property
A select box DATA TYPE 212 which is used to determine the data type of the data which will be stored by the property. In case of the meta-data storage, the data type selected here also determines which of the Content database tables (ContentText, ContentNumber, ContentLob, ContentDecimal and ContentDate) data stored by a given property will be stored in
A text input field WIDTH 214 which is used to determine the required width of the database column for storage of the data stored by a given property. If the object is of the type “Dynamic” and is stored in an external RDBMS table, this width will determine the width of the actual column of the RDBMS table automatically created as storage for the data stored by this property
A link, INPUT TYPE 216, which when selected causes an Instance Creation and Editing Window 250, shown in FIG. 14 and described below, to pop-up. The Instance Creation and Editing Window 250 enables users to create/edit/replace the form field used by the GUI for creation/editing of the data associated with a given property
A link, EXTERNAL FIELD 218, which when selected causes an External links window to be displayed. The External links window enables association of external database columns (or, in variants of the preferred embodiment, other data or pieces of data) with any given property. Using the External links window, the actual links between meta-data object properties and columns of external data (or other data) are created and maintained. By using the External links window, it can be determined, (and indicated to a user by generation of a display signal) whether a selected piece of data, for instance, database data is associated with an object or an instance, and the user can select an object and associated a selected piece of data with the object or the instance. In variants the preferred embodiment, instances of certain system objects are provided which are executable, in relation to particular applications, to determine automatically whether a selected piece of data, for instance, database data is associated with an object or an instance and to create an associated object or instance automatically if the selected piece of data is not associated with an object or an instance
A link, PERMISSIONS 220, which when selected causes a Permissions window 340, shown in FIG. 18 and described below to be displayed. The Permissions window 340 enables users to determine permission for any user group on the system to view/add/edit/delete the data stored against a given object property
A link, GROUPS 222, which when selected causes the display of a pop-up window which allows grouping of properties
A text input field, NAME 224, which enables a user to add or edit the actual property name. The difference between the NAME field 224 and the LABEL field 210 is that the NAME field displays the name used by the system and the LABEL field displays a name which is displayed to a user during operation of the system. Those two values can be different
A text area, CONDITION 226, which is used for adding/editing programmatic conditions which must evaluate to true in order for the property to be visible to the user. If this field is empty, as it is in its default state, the property is always visible
A checkbox, ACTIVE 228, which determines whether the property is active on the system
A checkbox, REQUIRED 230, which determines whether data to be stored in the property is required. If the checkbox 230 is checked, when adding/editing the instance, if this property is left blank, the user will be warned and processing halted.
A checkbox, DISPLAY 232, which determines whether data stored in the property will be visible or invisible to all the users
A checkbox, INLINE 234, which determines whether data stored in the property will be displayed as inline attributes of HTML tags
A checkbox, HIDDEN 236, which determines whether data stored in this property will be hidden
A checkbox, UNIQUE 238, which determines whether data stored in the property must be unique across all the instances of the given object
A checkbox, ENCRYPTED 240, which determines whether data stored in this property should be encrypted before persisting in database storage and decrypted when pulled out of the storage.

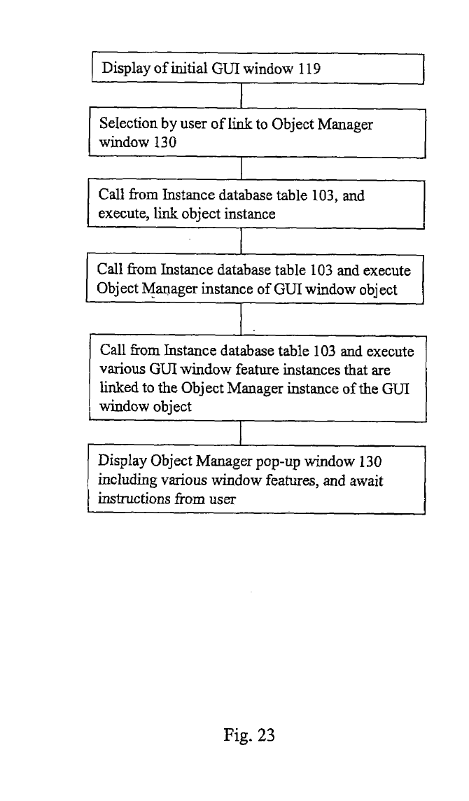

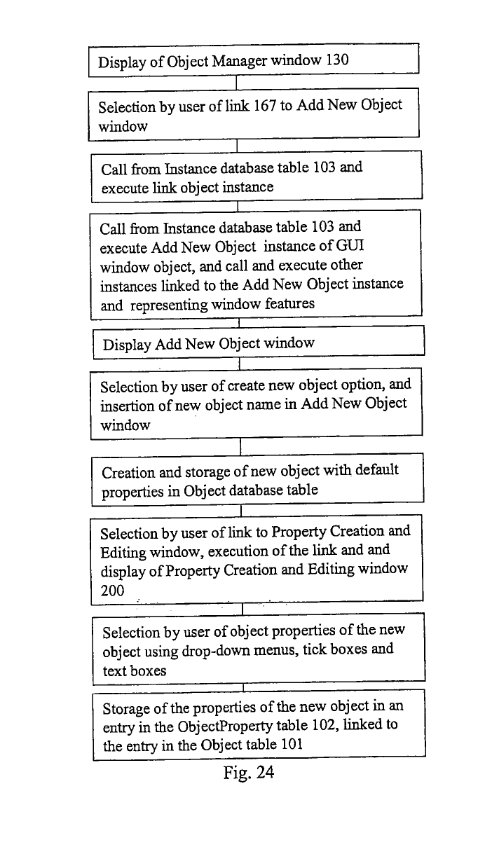

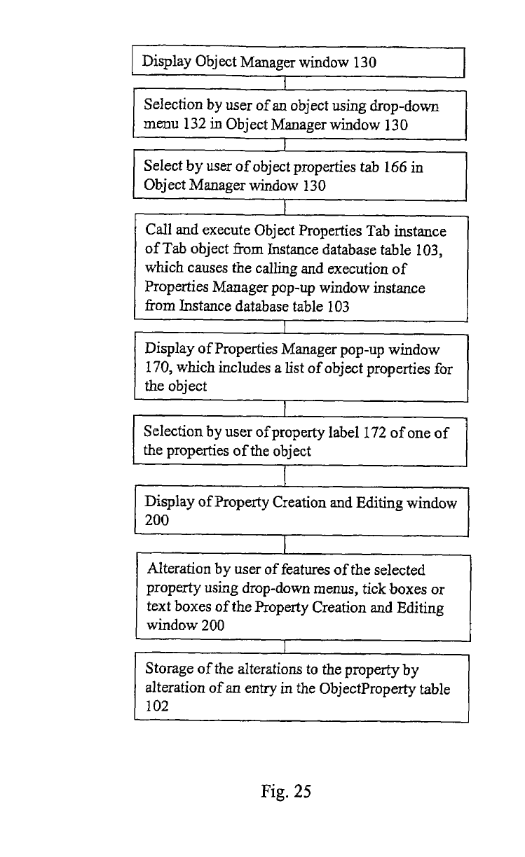

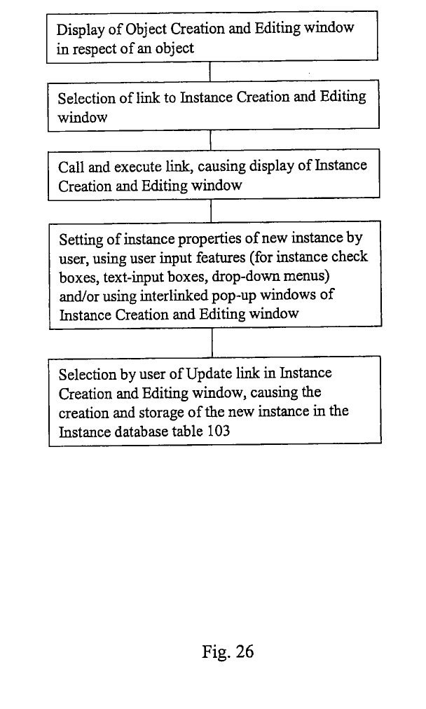

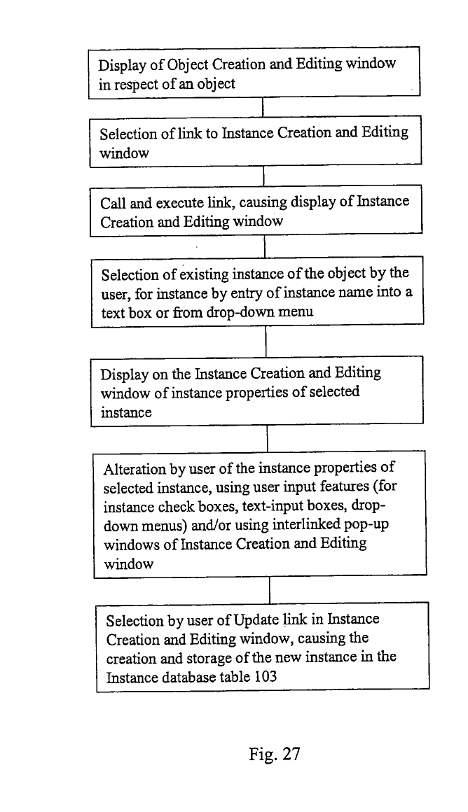

Objects can be created, edited and managed by the user using the various features of the GUI described herein starting from the Object Manager window 130. The processor 82 can create a new object or process a previously existing object, or assign properties to a new object or change properties of a previously existing object, in dependence upon input from a user via the GUI. The processes carried out in the preferred embodiment in order to display the Object Manager window 130, to create a new object, and to edit the properties of an existing object are illustrated in the flow charts of FIGS. 23 to 25.

The GUI windows shown in FIGS. 9 to 18 and 20 to 22 are examples of GUI windows according to the preferred embodiment. The form and content of the GUI windows can vary depending on the particular object that is being created, edited or managed. For instance the features that are displayed, and thus the options available for the user, in the Properties Manager window 170 can vary depending on whether the object that has been selected is, say, a webpage object or a database row object.

### Instance Creation and Management Via Instance Creation and Editing Window

Consideration is now given to Instance creation and management.

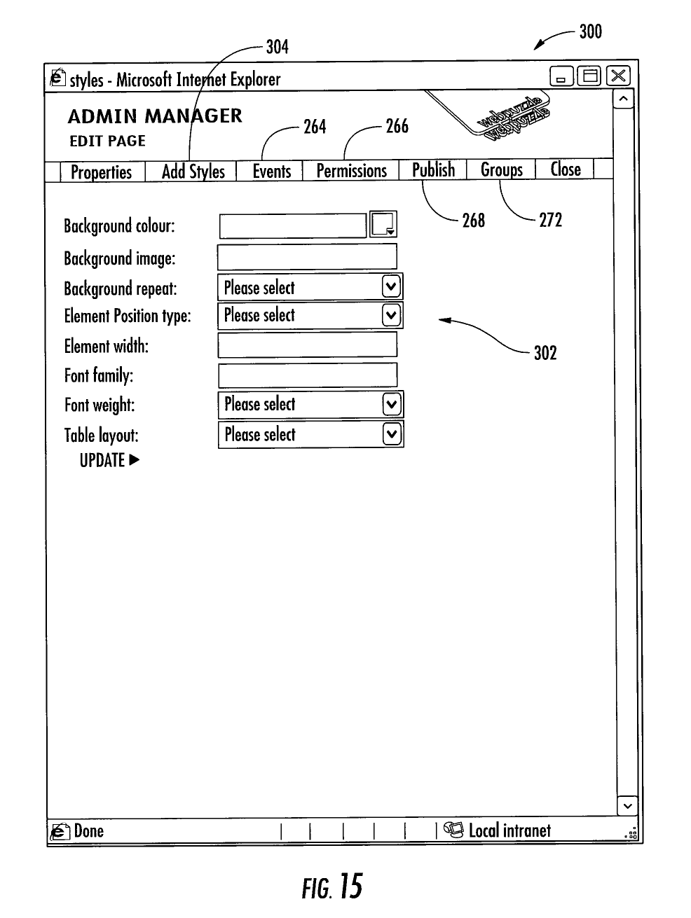

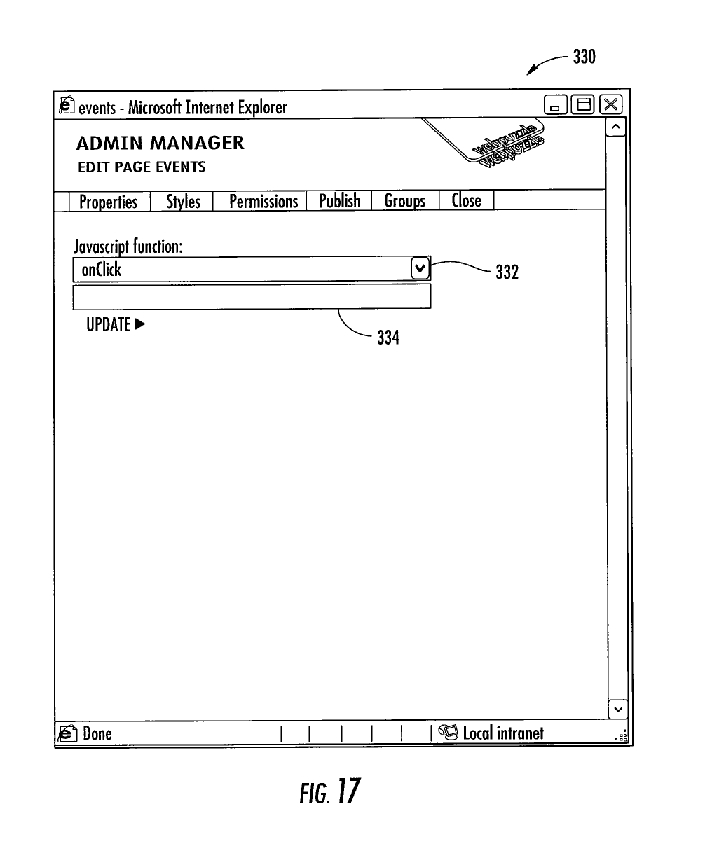

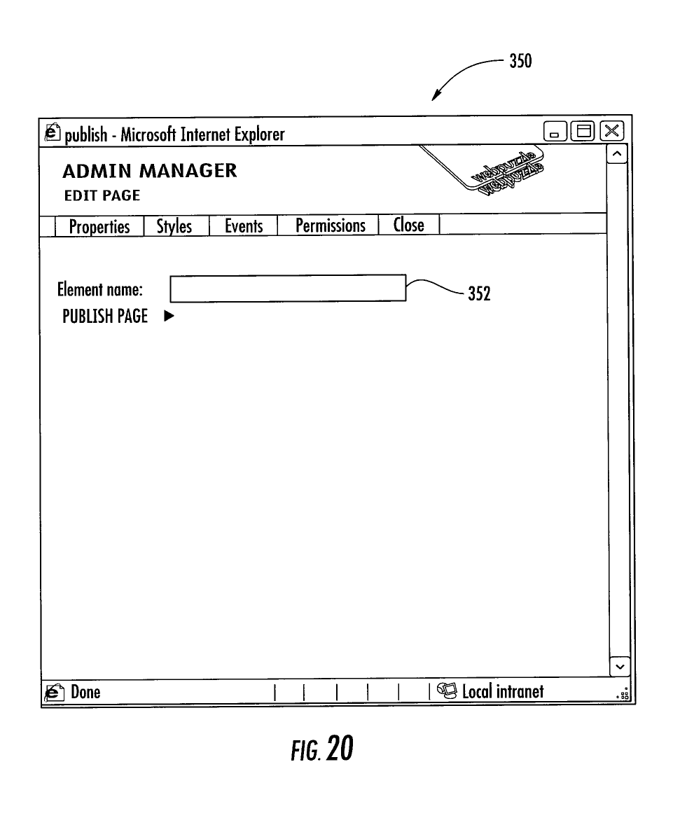

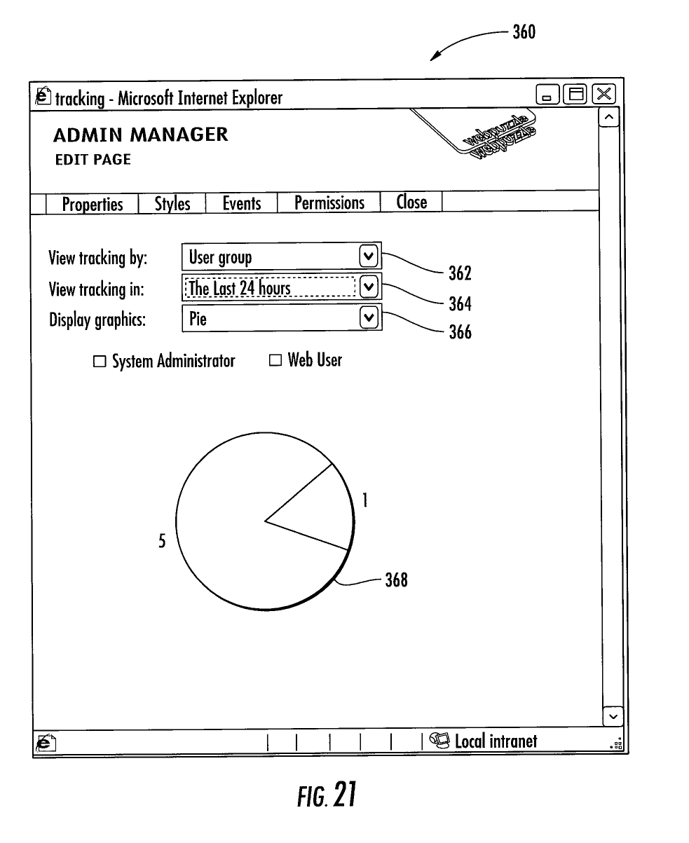

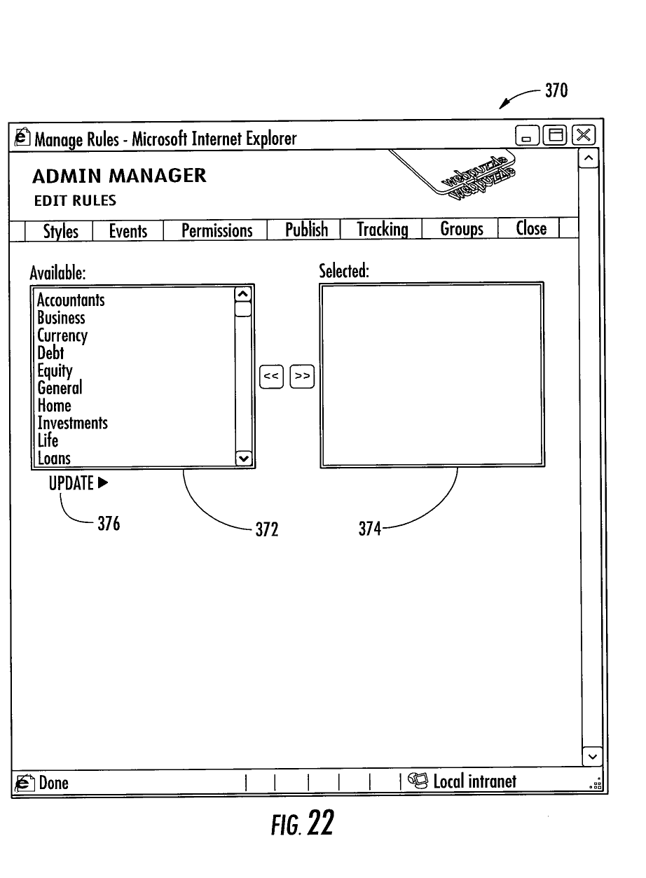

As mentioned above, selection of the link INPUT TYPE 216 in FIG. 13 causes an Instance Creation and Editing window 250 to be displayed. The Instance Creation and Editing window 250, as with any other window of the system, may also be accessed by links from other windows. An example of the Instance Creation and Editing window 250 is shown in FIG. 14 and includes the following features;
A Menu 260, which comprises the following entries:
A link, STYLES 262, which when selected replaces the currently displayed window with a Styles Editing window 300 which is shown in FIG. 15 and described in more detail below
A link, EVENTS 264, which when selected replaces the current window with a Javascript Events Editing window 330 (Javascript events include, for instance, onClick, on Hover) which is shown in FIG. 17 and described in more detail below
A link, PERMISSIONS 266, which when selected replaces the current window with a Permissions window 340, which is shown in FIG. 18 and described in more detail below. The Permissions window 340 enables a user to determine permission for any user group on the system to view/add/edit/delete the data stored against the given instance
A link, PUBLISH 268, which when selected replaces the current window with a Publish window 350, shown in FIG. 20, which allows a user to display or store selected pieces of data, or to pack the entire system (code and data) into easily manageable .zip files
A link, TRACKING 270, which when selected replaces the current window with a Tracking window 360, which is shown in FIG. 21 and described in more detail below. The Tracking window 360 allows a user to track and report on all the published user actions connected with a given instance (for instance viewing of a page, clicking on a link, selecting a choice from a select box)
A link, GROUPS 272, which when selected replaces the current window with the Groups window 370, which is shown in FIG. 22 and described in more detail below. The Groups window 370 enables a user to classify instances into various, user-created groups

The icons 274 appearing below the menu are links to add instances of the objects which are determined as children of the object whose given instance is currently being edited. So, as an example, inside the page a user can insert a button, a container, a Flash file, an image file by selection of one or more of the icons 274. The appearance and the order of the icons is determined by the select box 140 on an Object Manager window of the type shown in FIG. 11.

There are two types of fields displayed on the Instance Creation and Editing window 250, below the icons 274:
STATIC fields, comprising instance attributes which manage data within the database table “Instance” 103
DYNAMIC fields, which are created at runtime out of the INPUT FIELDS defined for properties as their data management form fields (see INPUT TYPE 216 described in relation to FIG. 13). These fields vary according to the objects and properties and are created and modified by users
The STATIC fields of the Instance Creation and Editing window 250 comprise:
A checkbox, TEMPLATE 276, which determines whether the given instance is to be treated as a template and be offered as an inheritable template when a new instance of the same object is being created
A checkbox, DYNAMIC 278, which determines whether the given instance's data can be cached in RAM or must be generated dynamically at every runtime
A checkbox HOME PAGE 280, which indicates whether any given page instance is a default home page for the given site instance (which is always a parent object of a page)
A checkbox, LOGIN PAGE 282, which indicates whether any given page instance is a login page for the given site instance (which is always a parent object of a page)

A select box, INSERT ANOTHER OBJECT INTO THIS PAGE 284, lists all the objects which are children of the object whose instance is currently being edited. Selecting an object from that select box replaces the current window with an Add New Instance window for the selected object.

A select box, CHILDREN 286, can be used either to order by moving the list entries up or down the children of the instance that is currently being edited, or to access instantly the editing window for the instance selected from the list. In this case, the children are instances of objects representing images or other features that may be included in a webpage.

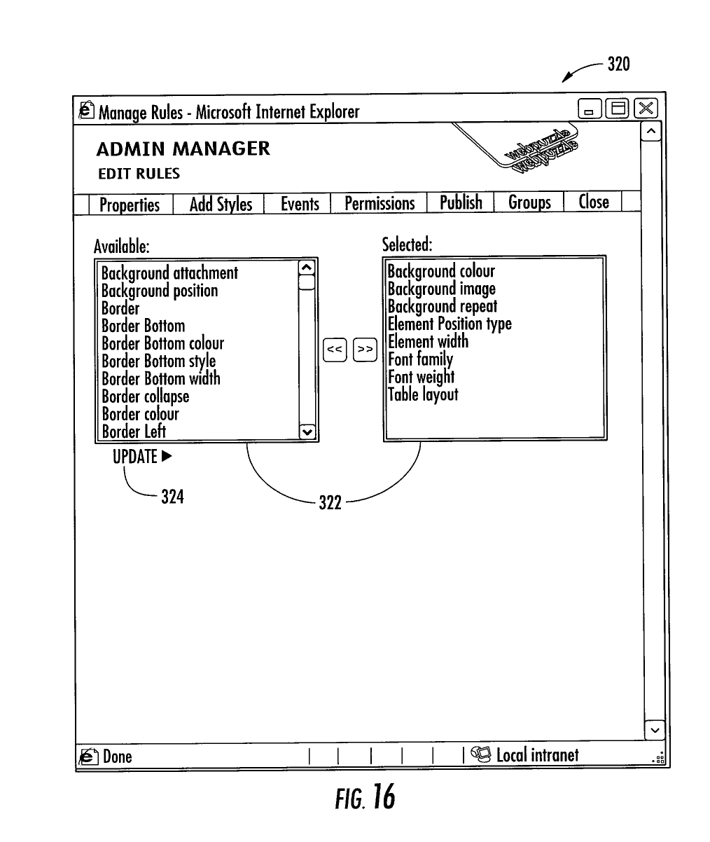

As mentioned above, selection of the link STYLES 262 of the Instance Creation and Editing window 250 of FIG. 14 replaces the currently displayed window with the Styles Editing window 300, as shown in FIG. 15. The Styles Editing window 300 comprises dynamically composed form fields 302 for adding/editing CSS styles belonging to an instance of an object. The form fields that appear on this window depends on the user-selected choice of styles on a style selection window 320, shown in FIG. 16, accessible via the menu link “Add Styles” 304 shown in FIG. 15.

The style selection window 320, shown in FIG. 16, comprises a double select box 322 and an Update link 324. In use, a user may move any number of selections, representing style commands from the left window to the right window of the double select box 322 and vice versa. If the user then clicks on the Update link 324, the style commands listed in the right hand window are assigned to the object in question. It can be seen in the example shown in FIG. 16 that the style commands listed in the right hand window determine the form fields which appear in the Styles Editing window 300 of FIG. 15.

As mentioned above, selection of the link EVENTS 264 of the Instance Creation and Editing window 250 shown in FIG. 14, replaces the current window with a Javascript Events Editing window 330, which is shown in FIG. 17. The Javascript Events Editing window 330 comprises a select box 332 which can be used to select a DHTML event and a text input box 334 where the javascript action to be executed upon the selected event can be entered. Then, any subsequent DHTML event associated with the object in question causes the corresponding javascript action to be performed. Any possible DHTML event, in particular any event associated with operation of a user input device for instance onClick or on Hover, may be selected using the select box 332, and an associated javascript action defined using the text input box 334.

By operation of the GUI windows shown in FIGS. 14 to 17 a user is able, for instance, to create an instance or change an existing instance using selection elements (for instance one or more of drop-down menus, buttons, tick boxes, text boxes) of the GUI windows.

In the preferred embodiment the particular GUI windows that are displayed to a user depend on the nature of the Instance in question, although many of the GUI windows have features in common. So, for instance, the GUI windows displayed to a user for creation and changing of an instance may be different for, say, a webpage instance than for, say, a process instance (such as a process applying a mathematical formula to the values stored in a database column), although many of the GUI window features relating to common actions are the same. The GUI windows shown in FIGS. 14 to 17 relate in particular to the creation of a webpage instance.

The instances that the user is able to create using the GUI windows may be GUI window instances. Such GUI window instances created by a user may relate to applications developed by a user using the system. So, for instance, a user is able to create using the GUI an object and associated instances relating to, say, a new process to be carried out on database data and is also able to create one or more GUI window instances related to the new process via which the new process can be requested or managed. The nature and functionality both of the user interface and of processes which may be managed using the user interface may be altered by a user him or herself, having the appropriate permissions.

### Permissions

As mentioned above, selection of the link PERMISSIONS 266 in the Instance Creation and Editing window 250 of FIG. 14 causes a Permissions window 340 to be displayed. The Permissions window 340 is shown in FIG. 18. The Permissions window 340 comprises the following features:
A select box, USER GROUPS 342, which allows a user to select a user group
A select box, PERMISSIONS 344, which allows for selection of permissions against the selected user group and the current instance. For example, in case of a page instance and user group “System Administrator”, as indicated in the example of 18, selecting choices “Edit”, “View” and “Add”, but not “Delete” allows all users belonging to the user group “System Administrator” to view page instances, add them and edit them, but not to delete them.

By using the Permissions window 340 a user is able to define, for each instance, the permissions which are necessary for another user to view, edit, add to or delete the instance.

### Display or Export of Data

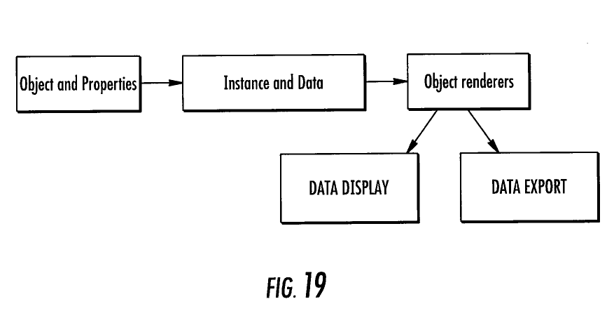

The basic sequence in which elements of the system are used in order to display or export data are shown in overview in FIG. 19. Firstly the object and its properties which link to the data in question are read from the object table. Next the instance, and any linked content data, which represent the data are read from the Instance and Content tables. Then, the instance and any linked content are used to populate the object and its properties. The resulting output data is passed to an object renderer (itself an instance of a renderer object). The object renderer operates to determine which display functions are used to graphically render the output data on the screen, if display of the instances is requested. The output data, suitably rendered if necessary, is then passed to a display device for display and/or a storage device (for instance a database) for storage.

An example of a GUI window used to request and manage display or export of data is shown in FIG. 20, which is a Publish window 350 used in the publishing of instances.

As mentioned above, selection of the link PUBLISH 268 in the Instance Creation and Editing window 250 of FIG. 14 replaces the current window with a Publish window 350, an example of which is shown in FIG. 20, which allows a user to pack the entire system (code and data) into easily manageable .zip files. The Publish window 350 comprises a text input box 352 where any name for the published page can be entered. Upon clicking the “Publish Page” link, all data representing the currently selected page will be packed into a convenient zip file containing XML files representing meta data. This zip file can easily be sent over email and un-wrapped at a remote server, automatically copying the entire page to the remote server.

By using the Publish window 350, a user is able to select and send to another location an instance or a set of instances.

In the preferred embodiment, a further Publishing GUI window is provided which enables the user to instruct the packing of all of the database tables 100 into a zip file, and the sending of zip file to another location. When the zip file is unpacked the entire system can be reproduced at the other location in a fully operational state. The user may also instruct the packing of external databases and other external data into the zip file if so desired.

### Tracking and Reporting

As mentioned above, selection of the link TRACKING 270 of the Instance Creation and Editing window of FIG. 14, replaces the current window with a Tracking window 360, which is shown in FIG. 21. The Tracking window 360 comprises:
a select box, VIEW TRACKING BY 362, allows users to select the criteria by which to view tracking data for an instance (for example, by user group or by country users belong to)
a select box, VIEW TRACKING IN 364, which allows users to select the time frame within which the tracked actions were executed (for example, “the last 24 hours”, “last week”, “last month”)
a select box, VIEW GRAPHICS 366, which allows users to select the type of graphic to represent the tracked data (for example, “pie”, “curve”, “horizontal bar”)
the graphic 368 representing the data obtained by tracking user actions upon an instance

In the preferred embodiment, each user of the system has a respective instance of a user object associated with them, and every action of the user is stored under his or her user instance in the Instance table 103.

The system includes a set of tracking and reporting objects and instances of those objects, which define a set of tracking and reporting tools. All actions taken by all users, either in general or relating specifically to particular other objects or instances, can be extracted, displayed and analysed, for instance on a per user, per user group, per time period, or per action type basis. The Tracking window 360 of FIG. 18 is an instance of one of the tracking and reporting objects, is linked to other tracking and reporting instances, and enables the display of data relating to actions taken concerning a particular instance on a user group basis and time period basis. In the example shown in FIG. 18, the number of times a particular web page instance has been accessed in the last 24 hours by users of particular user groups (either web user or system administrator in this case) is displayed in the form of a pie chart.

As mentioned above, selection of the link GROUPS 272 of the Instance Creation and Editing window 250 of FIG. 14, replaces the current window with the Groups window 370, which is shown in FIG. 22. The Groups window 370 comprises a double select box 372 374 and an Update link 376. A user may move any number of selections representing instance groups from the left window 372 to the right window 374 or the double select box 372 374 and vice versa. If the user clicks on the Update link 376, the current instance is assigned to all the groups appearing in the right window 374.

Various windows of the user interface in the preferred embodiment have been described above by way of example. The system may include a range of further windows, relating to functionality of system operations or to particular applications. The user, having appropriate permissions, is able to edit the windows and their functionality and is able to add additional windows with functionality determined by the user. Thus, each embodiment of the system may vary depending on the applications for which it is to be used, and may also vary over time as the user tailors the system, using the GUI tools and without additional programming, to have desired functionality and to be suitable for particular applications.

### Ram Caching

In the preferred embodiment, the database tables 100 are copied from the further memory 88 to the RAM 84 during the start up procedure, as mentioned above. As mentioned above, the database tables 100 provide a data store and also are so interlinked as to provide a data processing system, according to the preferred embodiment.

Subsequently, during operation of the system any changes to the objects, instances or content are saved in the copies of the database tables stored in the RAM 84. Periodically, the database tables stored in the further memory 88 are overwritten or updated by copying the database tables stored in the RAM 84 back to the further memory 88.

By caching objects, instances and data in RAM, the system provides added processing speed, stability, and scalability.

Both the data being used by a particular application and the application itself can be cached in the operating machine's RAM and run from there. That approach has a number of benefits:—
RAM is extremely scaleable and cheap
Response times for users are extremely fast (there is no need for applications to go off to external databases to call data)
if databases go down, or internet connection is lost, the applications continue to run without any obvious interruption from the user's perspective
as soon as the underlying data becomes available again, the cached version of the data is automatically refreshed. The system may be set to refresh in real time to reflect all changes to base data or at any specified interval
all dynamically generated pages created and displayed using the GUI can be set to automatically produce HTML files as soon as they are called by a user for the first time.

For instance, in the case of a set of instances of objects representing a web page, in the preferred mode of operation the HTML version of the page is served from RAM each time it is called by users, until the dynamic content of a page is changed. That ensures that users receive pages rapidly upon request and that they don't experience interruptions in service (should underlying servers go down). It also ensures that full search engine optimisation is inherent in all portals or websites created and operated using the system (the search engines can spider all cached pages/areas).

Various applications of the system are now considered.

### Applications of the Object-Oriented Data Processing System

As discussed above, the database tables 100 of the preferred embodiment provide a self-contained data processing system which can be managed by a user using a GUI. The user is able, for instance, to create, edit and delete objects and instances and create and edit relationships or links between objects and instances using the GUI. The objects and instances can, for instance, be processed to generate further GUI windows or to carry out new processes defined by the user or to link to, process or create relationships with external data or datasets. These features of the system can be used in a wide variety of applications.

Sets of objects and instances for use in particular applications can either be provided as system objects and instances of those system objects in the database tables 100 and thus be available immediately upon initial execution of the system, or can be created by a user using the GUI following initial execution of the system and subsequently stored in the database tables 100.

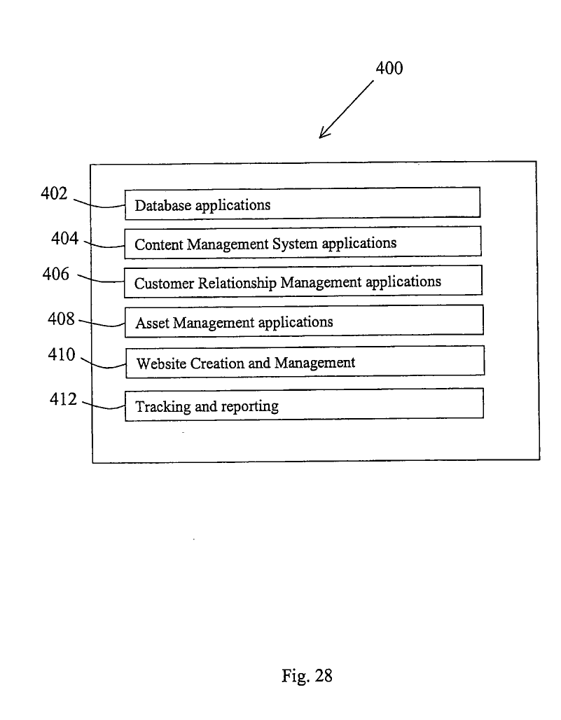

In the preferred embodiment, the sets of objects and instances for use in the applications discussed below are provided as system objects and instances of those system objects. Upon selection by a user of an applications link in the Menu area 120 of the initial GUI window 119, the applications window 400 illustrated schematically in FIG. 28 is displayed. The applications window 400 includes a database application link 402, a content management system (CMS) application link 404, a customer relationship management (CRM) application link 406, an asset management application link 408, a website creation and management link 410 and a tracking and reporting link 412. A user is able to move to GUI windows relating to each of the applications by selecting an appropriate link 402 404 406 408 410 412.

### Database and Legacy Data Applications

The system is able to handle legacy data and to create new databases. The system may be attached to any legacy databases in order to select, extract, integrate, manage and export data.

The Instance table 103 include object instances representing a variety of database queries or processes. The database queries or processes are carried out by execution of the object instances.

In use, a user is able to select one or more pieces of data (for instance, a database entry, a database row or column, or a database object, class or instance) which appear in the legacy databases. The user is also able to select particular fields or combinations of fields of the data. The user is able to select and to view or carry out processes on the selected pieces of data, selected fields or the selected combinations of fields. Indeed the user is able to carry out any database query or process which is available in known relational or object-oriented database systems. Each of those actions is carried out by using the appropriate GUI tools and associated database query or process instances.

The system in the preferred embodiment is configured so that the user is able to access, process and link database data in different external and/or legacy databases in a unified way. Indeed, depending on the configuration of the system, it may not be apparent to the user that particular pieces of data that he or she is querying or otherwise processing originate from different external and/or legacy databases.

The system is able to treat data from different databases in a unified manner by creating and storing in the Instance table 103 instances that represent pieces of data from the external and/or legacy databases. The system then carries out any further processing or retrieval of data by processing or retrieving the appropriate instances from the Instance table 103 rather than by processing or retrieving the corresponding data from the external and/or legacy databases, if the appropriate instances exist. Thus, processing or retrieval of data that originates from different databases can be carried out in a simple and efficient manner—even if the originating databases are of different types or have different formats.

In the preferred embodiment, the Instance table 103 is populated with instances representing pieces of data from the external and/or legacy databases, as and when those pieces of data are required.

Instances of system objects provided within the database tables automatically recognise the type of database or databases the system is dealing with (for example, SQL or Oracle) and cause the display of relevant data fields, from the databases in question, within the GUI.

Further instances of system objects, selected and executed by the user via the GUI, request particular pieces of data in order to carry out desired processes on the data. The system includes a further instance of a system object that determines whether there are instances in the Instance table that represent the requested the pieces of data. If there are such instances then the requested pieces of data are obtained by reading the corresponding instances from the Instance table 103 (and interlinked entries in the content tables if necessary).

If it is established, upon execution of the relevant instance of a system object, that there are no instances representing the requested pieces of data in the Instance table 103 then a further instance is executed which reads the requested pieces of data from the external and/or legacy databases, creates instances representing the pieces of data and stores the created instances in the Instance table 103 (and stores interlinked content in the content tables as necessary). If any of the requested pieces of data are subsequently requested again then the instances representing the pieces of data are read from the Instance table 103, rather than the pieces of data being called from the legacy and/or external databases.

It is a feature of the approach to populating the Instance table 103 with instances representing database data from legacy and/or database tables described in the preceding paragraph that the amount of data stored in the Instance table 103 and content tables is kept to a minimum, reducing storage requirements. That is a particularly important feature in circumstances where the legacy databases contain much old and no-longer useful data.

In an alternative embodiment, rather than creating instances representing only requested pieces of data, on an ad hoc basis, the system includes an instance of a system object which is operable to read all data existing in any external and/or legacy databases that are selected and to create and store in the Instance table 103 instances representing all data in the databases (and storing interlinked content in the content tables as necessary). That approach means that there is a possibility that redundant data is stored in the Instance table 103 and content tables, but can provided improved access speed which can be important for some applications.

Instances representing requests and processes instructed by the user are also created and stored in the Instance table 103.

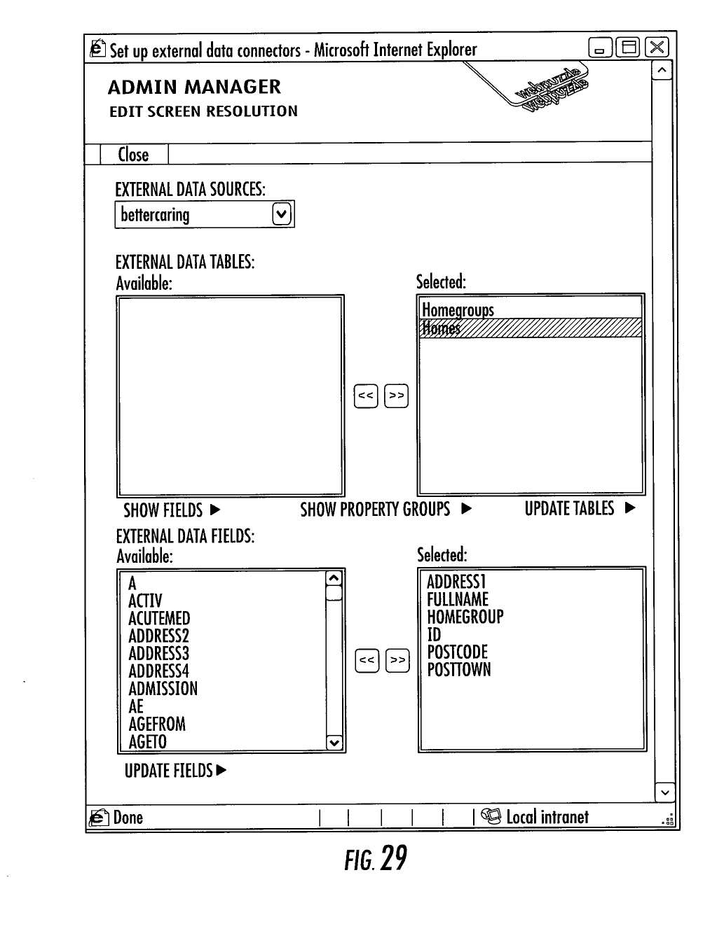

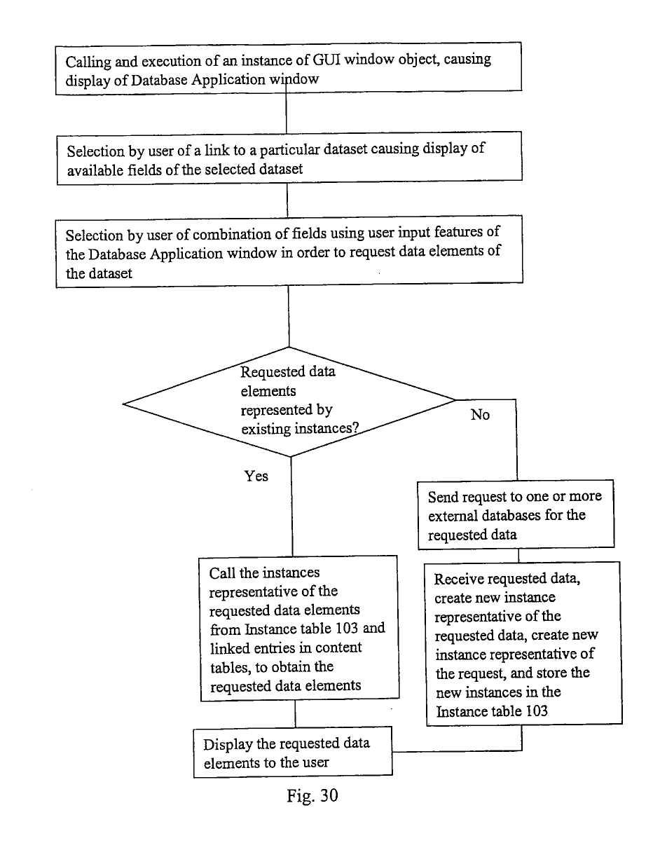

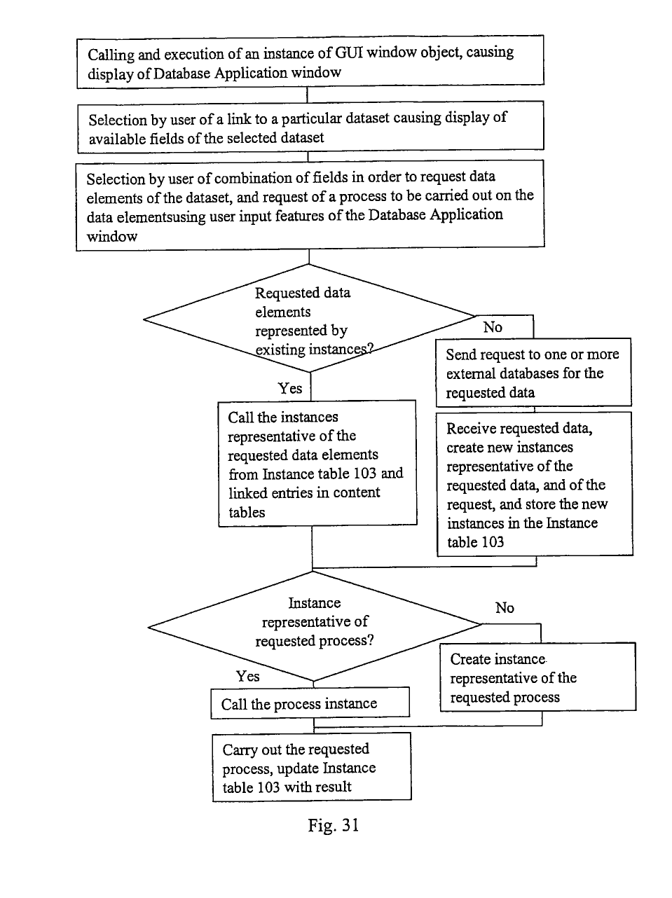

An example of a GUI window which a user may use to address and manage a legacy database is provided in FIG. 29. Flowcharts representing the reading and display of database data and representing the reading and update of database data are shown in FIGS. 30 and 31.

Changes to pieces of database data are performed by changing the instances in the Instance table 103 and/or content in the content tables. Corresponding changes may or may not also be made to the pieces of data stored in the external and/or legacy databases, depending on the mode of operation selected by the user.

The user is able to create new instances representing new pieces of data and also is able to add, remove or change relationships between pieces of data by adding, removing or changing attributes of objects or the instances of the objects representing the pieces of data.

Users can continue to run their legacy databases in parallel with the system or they can move to sole use of the system. When legacy systems are run in parallel with the system, new data entries and alterations to the legacy databases can be set to upload to the set of database tables 100 in real time (or at specified intervals). Likewise, relevant changes to data made in the set of database tables 100 of the system can be set to download into the legacy databases in real time (or at specified intervals).

The system provides completely granular data security (permission based) for any number of existing repositories and allows users to re-classify and integrate their data via the CRM and CMS tools in the GUI. In the preferred embodiment, the process of attaching the system to legacy databases (via the system's database application or CMS, CRM, AM or related reporting applications) in order to select, extract, integrate and manage data need not affect the legacy systems. Therefore, users have the option to either continue running their legacy databases in parallel with the system or they can choose to switch off their legacy systems and move to sole use of the system of the preferred embodiment.

### Webpage Creation and Editing

The system in the preferred embodiment can be used to create intranets, extranets, webportals and websites via the GUI, using a set of webpage creating and editing tools, without the need for a user to write any code.

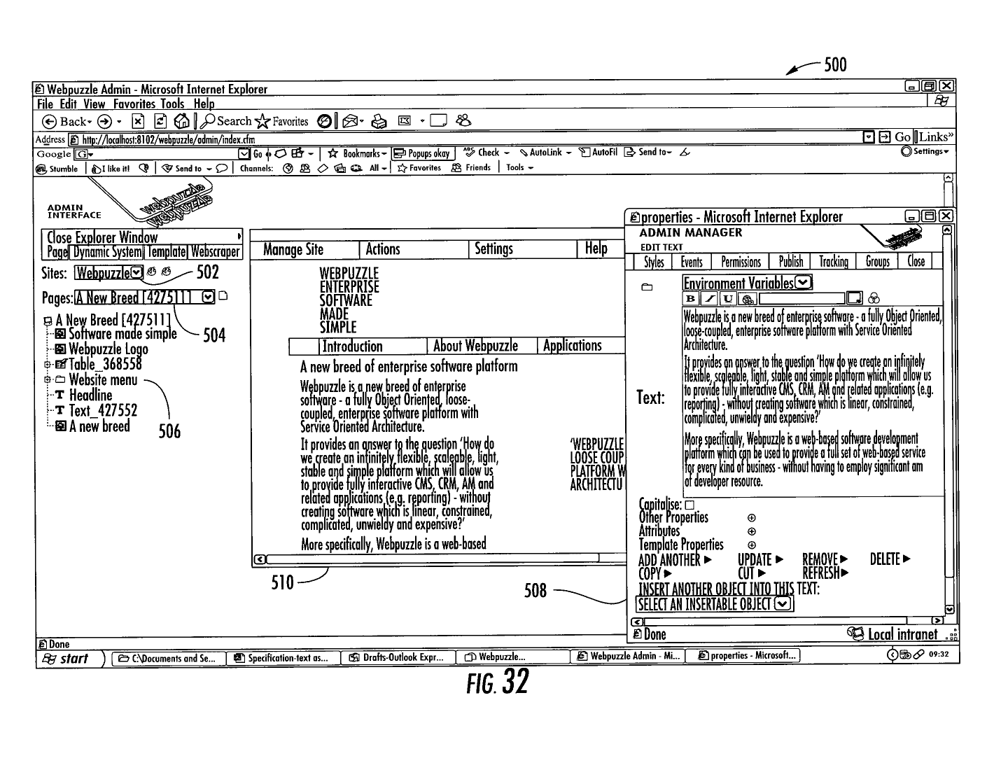

An example of a GUI window that can be used by the user in creating intranets, extranets, webportals and websites is shown in FIG. 32. The GUI window shown, and other interlinked windows, enable the user to select and execute instances of system objects enabling the creation and editing of webpages and the interlinking of such webpages.

In the preferred embodiment, as part of the webpage creating and editing tools, system objects are provided which are representative of HTML code that can be used in generation of a webpage. Each HTML command has an associated system object, and instances of that object can be used to generate that HTML command. So, for instance, there is an HTML system object representative of the Table command. An instance of that HTML table object specifies the table parameters and the data that is to be included in the table (either directly or by linking to an entry in a content table that contains the data). Execution of the instance of the table object causes creation and execution of the HTML table command populated with the parameters and data.

Webpage system objects are also provided. An instance of a webpage object comprises links to a set of HTML instances. Execution of the webpage instance causes execution of the HTML instances which in turn causes generation of HTML code representative of a webpage.

The HTML objects and instances and the webpage objects and instances can be created, edited and deleted in response to user input via the GUI, as is the case with all other objects and instances. GUI windows are provided which enable the user to select, typically from a list, particular features to be included on a webpage, the characteristics of those features (for instance, size, colour, position), and data to be displayed on the webpage.

In FIG. 32, an example of the editing of a webpage is illustrated. The main GUI window 500 of FIG. 32 includes a drop-down menu and associated text box 502 that identifies a website of which the webpage being edited forms part, and a drop-down menu and associated text box 504 that enables selection of a webpage being edited. The window 500 also includes a list 506 of the instances that make up the webpage. It can be seen that the list includes a text box instance, named Text_{—}427552. The text included in the text box instance is displayed for editing in window 508. The webpage being edited is displayed in further window 510, which shows how the webpage would appear during normal use.

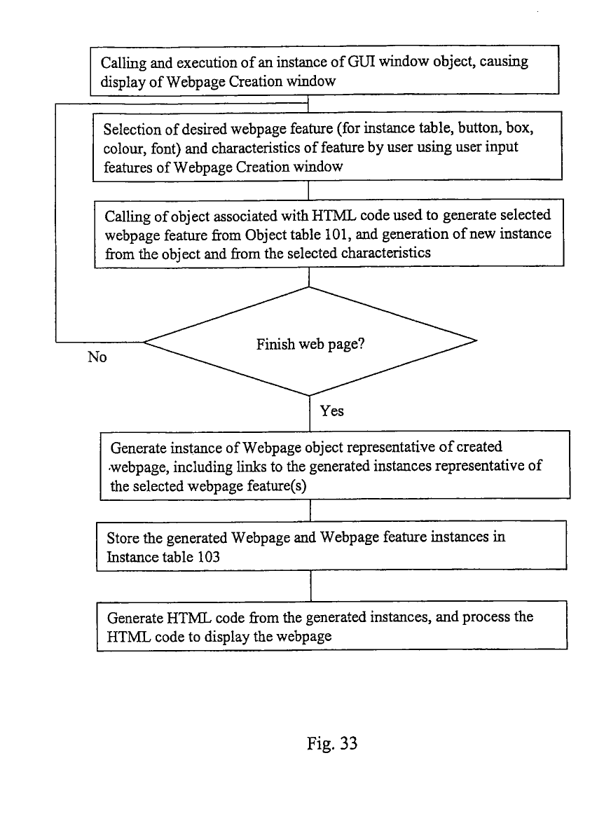

A flowchart is provide in FIG. 33 that illustrates in overview the steps involved in creation of a webpage by a user using the GUI.

The system also includes an instance of a system object that, upon execution, reads a selected, existing webpage and produces webpage instance representative of the webpage and a set of linked HTML instances each representative of a respective one of the pieces of HTML code used to generate the webpage. Subsequently, the user is able to modify the webpage instance and the linked HTML instances if desired using the GUI thereby altering the webpage. Thus, the system provides the capability to a user to modify existing webpages using the GUI and without the user himself having to recode the underlying HTML code directly, that recoding of the underlying code being performed automatically by the system in response to selection from a list of possible features by the user.

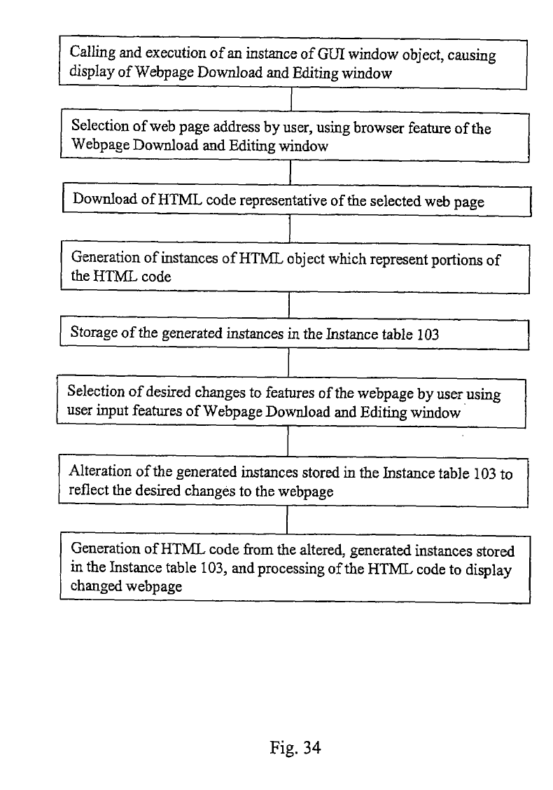

A flowchart is provide in FIG. 34 that illustrates in overview the steps involved in download of a webpage, and editing of the webpage by a user using the GUI.

The beginning of the process is user initiated. The user enters the url of the website which needs to be imported (for example, http://www.webpuzzle.co.uk/ in the example of FIG. 32).

The website is called via HTTP protocol. The underlying source code of the first, landing page of the website (usually index.html or default.html, etc) is parsed into a string of text. This string of text is than recursively tokenized into individual HTML tags. The system is able to parse all standard HTML tags and, optionally, customized HTML tags. All “<A>”, or anchor tags are than parsed in search of their “HREF” attribute (a pointer, link to another web page). If the pointer points to a page within the same website, all the pages are listed for the user on the GUI with select checkboxes, so that the user can select which pages he/she wishes to import.

When the selection of the pages is made, each of the selected pages is called via HTTP protocol and their source code is transformed into a string of text. Recursing through this string of text, all the HTML tags are recognized and recursively inserted into the table Instances under the appropriate object. Each object has a field “HTML TAG”. The value of this field must correspond to the name of the tag (e.g. “TABLE”, “A”, “SCRIPT”, etc).

Each HTML tag is than parsed for its attributes. These attributes are stored either as properties of the instances of the corresponding objects or as attributes of the corresponding objects.

The difference between properties and attributes in this context is in the fact that properties are assigned per individual object, while attributes can be assigned to many different objects. For example, the HTML tag “TABLE” has a specific attribute “border”, while almost all the HTML tags have attribute “style”. This is why “border” is a property specific to the object “TABLE”, while attribute “style” can be assigned to an instance of any object on the system.

Because HTML source code is recursive (“TD” tag is a child of “TR” tag, while “TR” tag is a child of “TABLE” tag, while “TABLE” tag is a child of the “BODY” tag and so on), all the instances corresponding to the parsed tags are stored within the system in the same, recursive manner, in a parent/child structure.

Javascript or any other script code embedded in the webpage, appearing between “SCRIPT” tags, is stored as an instance of a “text” object and this instance is stored as a child of a “script” object.

Style Sheet (CSS) code embedded in the webpage, appearing between “STYLE” tags, is stored as an instance of the “text” object and this instance is stored as a child of the “script” object.

Once all the tags, their attributes and content are stored as instances of corresponding objects, their properties and attributes and their content, the system provides a GUI, for example as shown in FIG. 32, that allows an administrator, or editor or other user to modify all the aspects of the webpage without touching the underlying source code in a what you see is what you get manner. For example, in FIG. 32, changes to the web page may be selected by the user via selection elements (for example, lists, text entry boxes, tick boxes and drop down menus) in window 508. The selection elements can also be used to add new features to the webpage, as well as changing existing features. For example, The changes are immediately implemented in the replica of the web page shown in window 510.

Once editing of the webpage has finished, the stored instances, properties and attributes are processed to generate amended web page code (for example HTML tags and/or script and style tags) representative of the amended web page. For each stored instance and associated content data representing properties or attributes, a corresponding output renderer (implemented in Java in this example) generates a string of text comprising a corresponding HTML or other tag, and associated attributes and content within the tag.

The process recurses through the children of the instances of the objects stored in the database and the children of their children in the string of text. The string of text is then saved as the underlying source code of an HTML file which is then exported, via ftp protocol in this example, back to the original hosting environment, for example a host server.

Once a web page has been imported the instances, properties and attributes stored in the tables can be linked to other applications, or can be altered by the user via other GUIs. For example, data from the content management system (CMS) can be incorporated into the web page via the GUI. The GUI is able to provide selection elements that enable incorporation of any instances, properties or attributes from any aspect of the system into the webpage.

The system can be configured so that any change in instances, properties or attributes representing the web page can be monitored, and updated HTML code, portions of HTML code or data can be exported in response to such changes for inclusion in the web page. As well as dynamically receiving updates from the system, a web page can also include dynamic elements that enable the passing of data or instructions back to the system. The data or instructions can be stored in the tables as objects, instances or properties. Thus, the web page can function as a dynamic web page, which interacts with the system, even if the original, imported web page was a static web page. The interaction between the web page and the system can be managed via AJAX components.

In one example, a static web site for a financial advisory company is read by the system from a host, the HTML code underlying the web site is converted to text, parsed to identify HTML and other tags and associated properties or attributes, and metadata and data representing the tags and associated properties and attributes are stored in the tables. Business data relating to the financial advisory company is also imported into the system, and stored in the tables, including data relating to particular financial advisors, such as biographies and photographs. The GUI is used to import that additional business data into the web site. A dynamic appointment diary module is also imported into the web site, with links back to the system tables. Web page code for generation of the amended web site is then generated by the system and exported back to the host. The amended web page subsequently available from the host includes the biographies and photographs of the financial advisors, together with a diary application provided by the diary module. A user is able to book an appointment with a particular advisor via the diary application, which then communicates with the system via an internet connection from the host to update appointment data stored by the system. The system in turn sends updated data back to the host to include in the web site showing that the booked time has now been taken.

In a variant of the described embodiment, web page import aspects of the system are implemented in a metadata-based but non-object oriented manner. The imported web page is converted to and stored as metadata and associated content data stored in interlinked table, and features of the web page are altered by altering the metadata and associated content data via a GUI, for example the GUI of FIG. 32. However, the metadata and content data are not treated as objects and instances of objects in that variant.

It can be understood that web page, creation, import or editing features of the described embodiments are able to provide the ability to integrate any existing data or dynamic features into an existing web page, even if that web page is a static web page.

In the mode of operation described above, users are able to automatically import and start editing any static website using the GUI and without having to write code. The import process is automated, takes minutes or less and can be managed using the browser-based GUI. The system provides a meta-data engine that supports the CMS (Content Management System) which allows users to automatically recreate the static content of any website as a content managed solution.

In described modes of operation, the system does not copy or re-create server side code. It reads each HTML/JavaScript/CSS code tag (visible to the browser) and translates each component of this code into an instance in the object data repository so that it can be used by system objects or other dynamic objects. These instances are combined and rendered on screen, to produce an exact replica of the “imported” static elements of the original website.

It is possible to edit, and add dynamic functionality to, the replica website using the GUI and without having to write code. The system also enables users to build new websites, pages or portals from scratch using the GUI and without having to write code

The browser-based GUI is suitable to be used by the end-users in a business, and enables such end users to perform tasks that would have been performed by direct coding by IT departments or developers in previous, known systems.

For example, in the case of a large scale application where a portal needs to be built from scratch, the traditional way of working would be that the site specification, site map, site design, page design and content would be defined by a management team. These requirements would then be passed to the IT department/developers to build.

In contrast, described embodiments in one mode of operation allows a management team or user to build ‘static’ functionality, and to employing pre-existing ‘dynamic’ functionality, in the live environment—using the GUI and without having to write any code.

Embodiments of the system also provide workflow management that enables users (with or without technical experience) to track instances of objects from creation through to publication and provides granular user permissions and object instance status.

The system, in certain embodiments, incorporates a range of proprietary dynamic modules covering the following areas of functionality: scheduling and booking, shopping online, data gathering, e-mail marketing, adding and tracking display advertising, creating multi-lingual websites, securing pages and sections of a website behind user login, managing users, and tracking user interaction with websites.

These dynamic modules can be dropped into static websites—which have already been either automatically recreated or created from scratch—using the GUI and without writing code. If these pre-built dynamic modules are not sufficient for all the server-side functionality required then additional dynamic modules can be built. Once built, such additional dynamic modules could be re-used for further applications and could be inserted into websites using the GUI and without writing code.

Users are able to automatically import and integrate data from any kind of data source (assuming that the user has username/password access to the relevant data sources, if required)

The system can also enables users to automatically integrate data from multiple external data sources (spreadsheets, .pdf, databases like Oracle, MSSQLServer, MySQL, etc.), or to manually create new sets of data, and to merge and manage this data inside the object data store—using the GUI and without having to write code. Integrated data can be exported to the Object Oriented databases provided by the system or exported back to the original data repositories, using the GUI and without writing code. The integrated data can be incorporated in new or existing web pages using the GUI.

In one mode of operation, the system is used to incorporate advertising (for example a banner or button) within a website via the GUI. Such advertising can be injected into clients' websites in a highly targeted way (for example, on a site type/subject basis, on a site user type basis, on a site by site basis, a site section basis, a site page basis, or a site page position basis), thus alleviating concerns that advertisers may have about controlling the context in which their advertising appears.

It also possible to dynamically track advertising using the system (every visitor and component of a website may be monitored and processed by the system as an object or an instance of an object)—using the GUI and without having to write code.

In one mode of operation, advertising is supplied to individual websites by a central provider using the system, and revenue is shared between the central provider and the individual website owners.

Re-created (or newly created) website pages can be hosted by the system or, as mentioned above, they can be exported as HTML files and can be hosted anywhere (including the website owner's original hosting environment—as a replacement for their original website or as a ‘development site’ running alongside the original website until such time as the owner is confident that they can switch off their original site).

Even if the website owner chooses to host their website externally, the dynamic components of their new website will continue to work and they will be able to control and update the website's data and content—provided the site remains in remote contact with the system, for example via an internet connection. In one embodiment, the system includes an AJAX layer, which maintains the link between the functionality provided by the system and an external hosting environment.

All components of any website or page imported, edited or created using the system can be tagged semantically to aid semantic searching—using the GUI and without having to write code. The system can be operated to automatically generate a site map and HTML copies of each web page. That process can be managed using the GUI and without writing code and provides search engine spiders with optimised access to all browser visible functionality.

In one mode of operation, the system is used to import existing web pages or sites that may be incompatible with particular web browsers, for example the most recent web browsers such as Internet Explorer 8, and to export versions of the web pages or sites that are compatible with those web browsers.

Embodiments relating to web page import, creation or editing are not limited to the use of objects, instances and properties as described above. Alternative embodiments are similar to those described but objects, instances and properties are replaced by entities, types and attributes.

### Content Management System (CMS) Applications

This area of application is concerned with the management and display of content on internet and intranet pages.

The system of the preferred embodiment provides a CMS with additional functionality because of its object-oriented nature. Because the system is object oriented, the applications which run on it including the CMS application are also object oriented.

In particular, users are able to build the CMS they require—and go on to edit and develop it—using the CMS tools available in the GUI, as well as being able to create and display pages (on the Internet or on extranets in the form of portals or websites). Users do not need to write any code. Instead, they use simple drop downs and click and drag functionality of the GUI as described above.

The CMS tools, which are instances of system objects, are linked both to the instances which provide database tools (enabling population of pages with data from databases) and to the instances which provide webpage and creation and tools, such as those described above.

### Customer Relationship Management (CRM) Applications

Customer relationship management (CRM) applications are chiefly concerned with the ability to define and communicate with ‘things’ (whether they types of people, types of clients/customers or products, components, data, etc. relating to people or clients/customers). This data is often held in many different types of database, in multiple locations, and may be categorised in many different ways. As mentioned above, the system of the preferred embodiment includes system objects that can be used to directly extract data from any type of database, and to store and process such data in a unified manner.

By way of example, the system can be pointed at an SQL or Oracle database (using the GUI) and, using the database tools, it will automatically recognise the type of database it is dealing with and display the relevant data fields, from the databases in question, within the GUI. A user can then select, extract, integrate and manage data, as required, using the GUI.

The system provides a set of CRM instances of system objects that provide a set of CRM tools and that are linked to the database instances providing the database tools. The CRM instances provide additional functionality that enable display and processing of data in a customer-specific way. So, for instance, the CRM tools may be set up to determine the format of correspondence (for instance letters and invoices) with a particular customer. In that example, the correspondence is populated with data extracted using the database tools.

### Asset Management (AM) Applications

The system of the preferred embodiment is also used to provide asset management (AM) applications which can be used to manage data assets (files), both for text and numerical based data and multi-media data.

In the preferred embodiment, every asset processed or stored by the system has a clearly defined location in the object oriented hierarchy defined by the database tables and every relationship this asset has to other assets can be identified and traced in its entirety via the object oriented hierarchy.

Users can create the exact type of AM application they require, and go on to edit and develop it, using the AM tools available in the GUI which provides drop-down menus and click and drag functionality, without writing code.

An enterprise using the system has the ability to both store, classify, index and access the full range of asset file types which exist and to integrate this ability across all areas of its business.

The AM tools provided by the system are linked to the database tools. The system can be directly attached to different types of data repository and it will automatically recognise the type of database it is dealing with and will display the relevant data fields, from the databases in question, within the GUI, using the database tools.

The AM tools include executable instances of system objects that define processes to be carried out on data (which may have been obtained using the database tools).

In one example, the AM tools provide the ability to determine the format of a selected piece of data, and to convert the selected piece of data into a different format. Thus, the ability to process data in a format-agnostic way can be provided. That can be particularly useful in the case where it is desired to provide or develop processes which include the processing together of existing pieces of data that are of different formats.

In the preceding example the AM tools include an instance of a system object that, upon execution, identifies the format of a piece of data, either by reading an instance that represents the piece of data from the Instance table 103 or by reading the piece of data directly. The instance is pointed at, or otherwise associated with, the piece of data upon command of the user using the GUI. The AM tools also include a set of executable instances each of which, upon execution, converts a piece of data from one format to a different format. In the preferred mode of operation the appropriate one of those executable instances converts the piece of data by suitably modifying an instance representative of the piece of data or by creating a new instance representative of the piece of data in the different format.

The output of the data format conversion process using the AM tools can be linked to other system tools, to ensure that further processes controlled by those tools operate on data in the appropriate format.

In another application, the data format conversion process provided by the AM tools are used in a stand-alone process, in which data sets in one or a range of formats are converted into a desired format. In particular a web-based service is provided in which format conversion of data submitted by a user having appropriate authorisation is carried out using the AM tools. Authorisation of the user is determined by the entering of a correct password by the user. The service may be a subscription service in which the user is provided with a password in return for subscribing to the service.

### Tracking and Reporting

The system provides an enterprise with the ability to track and report on every action carried out by a user in every type of application (for instance CRM, CMS, intranets, extranets, websites).

Users can build the exact type of tracking and reporting application they require, and go on to edit and develop it, using the tracking and reporting tools available in the GUI.

Because the system, and all the applications created with or provided within the system, are object oriented, users of these applications are also object oriented (users, whether internal or external, are automatically classified as further objects within the overall object oriented hierarchy). The system provides tracking and reporting system objects. Examples of instances of those objects contain, for instance, a record of all actions taken by a particular user, all actions taken within a particular period, all actions of a particular type, or indeed any other desired record of system usage. The system can be configured so that the instances of the tracking and reporting objects are updated following every action that is taken. As with all other objects and instances, the tracking and reporting objects and instances can be created, modified or deleted by the user using the GUI, and analysis of usage can be undertaken by processing the tracking and reporting instances.

The preferred embodiment described above uses object oriented techniques to provide a self-contained processing system which includes a GUI that can be used to create and edit objects and instances without the need for coding by a user, and that can be adapted to a range of different applications. Each of the individual objects and instances described above considered in isolation, which form part of the system, can be produced using known object-oriented techniques. The system is not limited to any particular set of objects and instances. Indeed one of the strengths of the system is that the set of objects and instances may be adapted or extended in any way desired by the user using the GUI that forms part of the system.

In one example of an application, the system is used in managing a chain of cinemas. In such an application, the objects provided by the system include the following:—
Cinema object (this is a “root” object, the parent of all the other objects, the top of the hierarchy) having properties of address (object) and screen (object).
Address object contains addresses and is multi-purpose, and may be integrated by a variety of other objects that need to have an address as one of their properties. Its properties are typical address properties, for instance house number, street name, post code, county, and telephone number.
Screen object is a child of the cinema object or one of its properties. The screen object itself would have properties of, for instance, number of seats, and seating plan.
Film is a child of the Screen object and comprises properties of for instance director, actors (object), summary, and duration.
Actor object comprises properties of, for instance, name and surname.
Ticket object is a child of cinema and comprises properties of, for instance, price, seat number.

The use of a combination of objects, for instance the listed objects, allows the creation of a business application for managing the chain of cinemas, in particular on-line bookings.

In another example, the system is used in management of a car rental agency. In that case, the objects include, for instance:—
Agency (properties: address, employees)
Address (see above cinema corp. for reference)
Employee (properties: job title, name, surname)
Car object (properties: make, model, colour, no. of seats, engine size)
Price object is a child object of the Car object (properties: currency, total).

The use of a combination of objects, for instance the listed objects, allows the creation of a business application for managing a car rental agency, and in particular on-line bookings.

Various embodiments described above relate to an object oriented data processing system, and in particular that relates to a data processing system based on a set of interlinked tables that store or represent objects, instances and properties. Alternative embodiments are not limited to the use of such objects, instances and properties. For example, in certain alternative embodiments the objects, instances and properties are replaced by entities, types and attributes. So, for example, in the case of web import, creation or editing embodiments there are also alternative embodiments that are similar but in which the objects, instances and properties described in relation to such embodiments are replaced by entities, types and attributes.

It will be understood that the invention has been described above purely by way of example, and modifications of detail can be made within the scope of the invention.

Each feature disclosed in the description and (where appropriate) the claims and drawings may be provided independently or in any appropriate combination.

1. A method of processing a webpage comprising:—
downloading and reading webpage code representative of a webpage from a host, wherein the webpage code comprises a plurality of pieces of webpage code each representative of a webpage feature;
processing the webpage code to produce a set of instances of webpage code objects and at least one of associated properties and associated attributes, wherein each webpage code instance is representative of a respective one of the pieces of webpage code;
storing the webpage code instances and the at least one of associated properties and associated attributes;
displaying a graphical user interface (GUI) representative of at least one of: —the webpage code instances, associated properties and associated attributes;
receiving instructions from a user via the GUI to alter at least one feature of the webpage;
in response to the instructions from the user, at least one of: —changing at least one property of the set of webpage code instances; changing at least one attribute of the set of webpage code instances; and adding at least one new webpage code instance to the set of webpage code instances;
generating amended webpage code from the set of webpage code instances and said at least one of associated properties and associated attributes; and
exporting the amended webpage code.

2. A method according to claim 1, wherein the storage of the webpage code instances and said at least one of associated properties and associated attributes comprises storing in a database metadata representative of the webpage code instances and storing in the database content data representative of said at least one of associated properties and associated attributes.

3. A method according to claim 2, wherein the database is a dynamic database and the method further comprises in response to a change in content data or metadata stored in the database automatically generating amended webpage code, and exporting the amended webpage code.

4. A method according to claim 2, wherein the database further comprises at least one of additional content and applications, and the method further comprises including at least one of said additional content and said applications in the webpage in response to a user selection via the GUI.

5. A method according to claim 4, wherein the additional content and applications comprise at least one of advertising content and dynamic content.

6. A method according to claim 4, wherein the applications comprise at least one executable application that is executable to communicate with the database.

7. A method according to claim 4, wherein the least one of additional content and applications comprises at least one dynamic module providing at least one of scheduling and booking functionality, online shopping functionality, data gathering functionality, e-mail marketing functionality, display advertising, tracking of advertising, multi-lingual website creation, security functionality, user login functionality, user management functionality, and user-website interaction monitoring.

8. A method according to claim 1, wherein the GUI comprises at least one selection element for selecting at least one of: —features to be included on the webpage; characteristics of features to be included on the webpage; and data to be displayed on the webpage.

9. A method according to claim 1, wherein the GUI comprises a replica of the webpage to be edited and at least one selection element operable to alter at least one feature of the webpage.

10. A method according to claim 1, wherein the GUI comprises at least one selection element operable to select at least one new feature to be added to the webpage.

11. A method according to claim 1, wherein the processing of each piece of webpage code comprises identifying a tag and at least one of an associated property and an associated attribute, and storing metadata representative of each tag and storing content data representative of said at least one of an associated property and an associated attribute.

12. A method according to claim 1, wherein the processing of the webpage code comprises converting the webpage code to text, and parsing the text to identify tags and at least one of associated properties and associated attributes.

13. A method according to claim 1, wherein the webpage code comprises HTML code, and the processing of the webpage code comprises identifying HTML tags and at least one of properties and attributes associated with the HTML tags.

14. A method according to claim 13, wherein the webpage code further comprises at least one of style and script code, and the processing of the webpage code comprises identifying at least one of style and script tags and at least one of properties and attributes associated with the style and script tags.

15. A method according to claim 1, wherein the generation of webpage code comprises, for each webpage code instance, generating a tag from that webpage code instance, generating text representative of at least one of an associated property and an associated attribute of that webpage code instance, and inserting the generated text within the tag.

16. A method according to claim 2, wherein the database comprises a plurality of interlinked tables, each comprising a plurality of table entries.

17. A method according to claim 16, wherein the number of tables is less than 20.

18. A method according to claim 16, wherein the table entries comprise at least one of metadata and content data, and associations between webpage code instances and at least one of associated properties and associated attributes are represented by links between the table entries.

19. A method according to claim 16, wherein the links between webpage code instances are represented by links between the table entries.

20. A method according to claim 1, wherein the downloaded webpage code is representative of a static webpage and the exported, amended webpage code is representative of a dynamic webpage.

21. A method of processing a webpage comprising:—
downloading from a host webpage code used to generate a webpage, wherein the webpage code comprises a plurality of pieces of webpage code;
processing the webpage code to produce metadata and associated content data representative of the webpage;
storing the metadata and associated content data in a database;
monitoring the database for changes to stored metadata or associated content data;
generating amended webpage code in response to changes to stored metadata or content data; and
exporting the amended webpage code to the server.

22. A system for processing a webpage comprising:—
a processor configured to download webpage code representative of a webpage from a host and to process the webpage code to produce a set of webpage code object instances and at least one of associated properties and associated attributes, wherein the webpage code comprises a plurality of pieces of webpage code each representative of a webpage feature, and each webpage code instance is representative of a respective one of the pieces of webpage code;
a data store for storing the webpage code instances and said at least one of associated properties and associated attributes; and
a graphical user interface (GUI) representative of the webpage code instances and said at least one of associated properties and associated attributes, wherein:—
the GUI is operable to receive instructions from a user to alter at least one feature of the webpage;
the processor is operable to at least one of change at least one of a property ad an attribute of the set of webpage code instances, and add at least one new webpage code instance to the set of webpage code instances; and
the processor is further operable to generate amended webpage code from the set of webpage code instances and said at least one of associated properties and associated attributes, and to export the amended webpage code.

23. A computer program product comprising processor-executable code for processing a web page, the processor-executable code comprising instructions for:—
downloading webpage code representative of a webpage from a host, wherein the webpage code comprises a plurality of pieces of webpage code each representative of a webpage feature;
processing the webpage code to produce a set of instances of webpage code objects and at least one of associated properties and associated attributes, wherein each webpage code instance and said at least one of associated properties and associated attributes is representative of a respective one of the pieces of webpage code;
storing the webpage code instances and said at least one of associated properties and associated attributes;
displaying a graphical user interface (GUI) representative of at least one of: —the webpage code instances, associated properties and associated attributes;
receiving instructions from a user via the GUI to alter at least one feature of the webpage;
in response to the instructions from the user, at least one of: —changing at least one property of the set of webpage code instances, changing at least one attribute of the set of webpage code instances, and adding at least one new webpage code instance to the set of webpage code instances;
generating amended webpage code from the set of webpage code instances and said at least one of associated properties and associated attributes; and
exporting the amended webpage code.
